(19) United States
(12) Patent Application Publication
(10) Pub. No.: US 2008/0147463 A1
(43) Pub. Date: Jun. 19, 2008

(54) Methodology, processes, and system for selection and optimization of collaborative management opportunities between internal and external organizations so that return on investments can be maximized

(76) Inventor: Stephen L. Starling, Carlsbad, CA (US)

Correspondence Address: Attorney Richard S Missimer, PO Box 49, Hartford, WI, 53027-0049, US

(21) Appl. No.: 12/001,895

(22) Filed: Dec. 13, 2007

Related U.S. Application Data
(60) Provisional application No. 60/875,159, filed on Dec. 14, 2006.

(51) Int. Cl. G06Q 10/00

(52) U.S. Cl. 705/7

(57) ABSTRACT

A business process, “Developing Robust Roadmaps Integrating Value Enterprises” (DR²IVE), for maximizing the efficiency of project and resource management and expanding a firm's Efficient Frontier, a model by which project portfolios can be evaluated and selected for most favorable impact. DR²IVE embodies five core processes; Design, Score, Audit, Roadmap, and Robust intended to collectively expand an organization's Efficient Frontier and yield greater returns while optimizing resource usage. This end is achieved through enabling professionals to create actionable Robust Roadmap that justify opportunities and coordinate collaboration among departments, divisions, business units, enterprises, alliances, mergers, acquisitions, governments and other endeavors between multiple organizations. The aims or DR²IVE are to increase the return on the existing portfolio of project proposals through organizational sharing and synergies and, through the increase in returns, to increase the number and viability of new and future project proposals.

### CROSS REFERENCE TO RELATED APPLICATION

This inventor claims priority from a U.S. Provisional Patent application No. 60/875,159 filed Dec. 14, 2006.

### BACKGROUND OF THE INVENTION

The fields of Supply Chain Management, Alliance Development, Project Portfolio Management and Strategic Management have undergone major advances in the last two decades; however, there is a lack of process based methodologies to fully leverage the synergistic opportunities for collaboration between organizations at all levels: departmental, business unit, division, enterprise, alliance and (supply) chain. The inventor of the methodology contained herein discovered through extensive literature reviews and interactions with industry that a need exists for a tangible process based methodology that: brings organizations together to plan collaborative engagements, measure their current management capabilities against world-class capabilities, compare the gaps (and strengths) discovered with collaborative organizations, identify where one organization can aid the other, develop projects based on the identified opportunities and then network and manage the projects. No process in existence has thus far addressed these needs simultaneously in a single model.

### DISCUSSION OF THE RELATED ART

The Efficient Frontier as identified by Dr. Harry Markowitz is a model by which project portfolios can be evaluated and selected for optimal impact. The Efficient Frontier defines a curve along which the best possible combinations of project portfolios lie. U.S. Pat. No. 5,884,287 (Edesess, 1999) discusses in detail the concepts behind Dr. Markowitz's Efficient Frontier. U.S. Pat. No. 5,148,365 (Dembo, 1992) discusses ways to make determinations of scenarios based on mathematical models but does not go farther. U.S. Pat. No. 6,678,671 (Petrovic et al, 2004) combined resource management and project management using computer based technology but falls short of the returns available though these procedures and methodology.

### BRIEF SUMMARY OF THE INVENTION

This inventor has determined a methodology, processes and system that optimizes the return of investment of the project portfolio. This is done by using the Efficient Frontier in a way that combines the shared resources of multiple organizations in combinations that optimize the returns on project investments. Multiple organizations include internal enterprise entities, such as other departments, divisions and business unit, as well as external entities the organization wishes to collaborate with such as partnerships, alliances, mergers, acquisitions, suppliers and customers. Adding collaborative projects to an organization's project portfolio will result in increases in the overall return on investment since the projects are selected based on return measures alongside existing project proposals in the portfolio.

### BRIEF DESCRIPTION OF THE DRAWINGS

FIG. 1—Circular flow diagram of DR²IVE

FIG. 2—DR²IVE process of sequential phases

FIG. 3—Expansions of the Efficient Frontier Using DR²IVE Processes

FIG. 4—Detailed View of the DESIGN Process' Define Phase

FIG. 5—Phase steps, responsible parties, deliverables, and associated math for the DESIGN Process' Define Phase.

FIG. 6—Detailed View of the DESIGN Process' Explore Phase

FIG. 7—Phase steps, responsible parties, deliverables, and associated math for the DESIGN Process' Explore Phase.

FIG. 8—Detailed View of the DESIGN Process' Select Phase

FIG. 9—Phase steps, responsible parties, deliverables, and associated math for the DESIGN Process' Select Phase.

FIG. 10—Calculating Scores (Includes Subfigures A-J)

FIG. 11—Detailed View of the DESIGN Process' Involve Phase

FIG. 12—Phase steps, responsible parties, deliverables, and associated math for the DESIGN Process' Involve Phase.

FIG. 13—Detailed View of the DESIGN Process' Gauge Phase

FIG. 14—Phase steps, responsible parties, deliverables, and associated math for the DESIGN Process' Gauge Phase.

FIG. 15—Detailed View of the DESIGN Process' Negotiate Phase

FIG. 16—Phase steps, responsible parties, deliverables, and associated math for the DESIGN Process' Negotiate Phase.

FIG. 17—Detailed View of the SCORE Process' Score Phase

FIG. 18—Phase steps, responsible parties, deliverables, and associated math for the SCORE Process' Score Phase.

FIG. 19—Detailed View of the SCORE Process' Consensus Phase

FIG. 20—Phase steps, responsible parties, deliverables, and associated math for the SCORE Process' Consensus Phase.

FIG. 21—Calculating Consensus Indices (Includes Subfigures A-G)

FIG. 22—Detailed View of the SCORE Process' Optimize Phase

FIG. 23—Phase steps, responsible parties, deliverables, and associated math for the SCORE Process' Optimize Phase.

FIG. 24—Detailed View of the SCORE Process' Review Phase

FIG. 25—Phase steps, responsible parties, deliverables, and associated math for the SCORE Process' Review Phase.

FIG. 26—Detailed View of the SCORE Process' Engage Phase

FIG. 27—Phase steps, responsible parties, deliverables, and associated math for the SCORE Process' Engage Phase.

FIG. 28—Detailed View of the AUDIT Process' Analyze Phase

FIG. 29—Phase steps, responsible parties, deliverables, and associated math for the AUDIT Process' Analyze Phase.

FIG. 30—Detailed View of the AUDIT Process' Understand Phase

FIG. 31—Phase steps, responsible parties, deliverables, and associated math for the AUDIT Process' Understand Phase.

FIG. 32—Detailed View of the AUDIT Process' Discover Phase

FIG. 33—Phase steps, responsible parties, deliverables, and associated math for the AUDIT Process' Discover Phase.

FIG. 34—Detailed View of the AUDIT Process' Integrate Phase

FIG. 35—Phase steps, responsible parties, deliverables, and associated math for the AUDIT Process' Integrate Phase.

FIG. 36—Detailed View of the AUDIT Process' Transfer Phase

FIG. 37—Phase steps, responsible parties, deliverables, and associated math for the AUDIT Process' Transfer Phase.

FIG. 38—Detailed View of the ROADMAP Process' Review Phase

FIG. 39—Phase steps, responsible parties, deliverables, and associated math for the ROADMAP Process' Review Phase.

FIG. 40—Calculating Opportunity Indices (Includes Subfigures A-G)

FIG. 41—Detailed View of the ROADMAP Process' Opportunity Phase

FIG. 42—Phase steps, responsible parties, deliverables, and associated math for the ROADMAP Process' Opportunity Phase.

FIG. 43—Detailed View of the ROADMAP Process' Agree Phase

FIG. 44—Phase steps, responsible parties, deliverables, and associated math for the ROADMAP Process' Agree Phase.

FIG. 45—Calculating the DR²IVE Project Value Index (Includes Subfigures A-D)

FIG. 46—Detailed View of the ROADMAP Process' Develop Phase

FIG. 47—Phase steps, responsible parties, deliverables, and associated math for the ROADMAP Process' Develop Phase.

FIG. 48—Detailed View of the ROADMAP Process' Milestone Phase

FIG. 49—Phase steps, responsible parties, deliverables, and associated math for the ROADMAP Process' Milestone Phase.

FIG. 50—Detailed View of the ROADMAP Process' Authorize Phase

FIG. 51—Phase steps, responsible parties, deliverables, and associated math for the ROADMAP Process' Authorize Phase.

FIG. 52—Detailed View of the ROADMAP Process' Proceed Phase

FIG. 53—Phase steps, responsible parties, deliverables, and associated math for the ROADMAP Process' Proceed Phase.

FIG. 54—Detailed View of the ROBUST Process' Review Phase

FIG. 55—Phase steps, responsible parties, deliverables, and associated math for the ROBUST Process' Review Phase.

FIG. 56—Detailed View of the ROBUST Process' Opportunity Phase

FIG. 57—Phase steps, responsible parties, deliverables, and associated math for the ROBUST Process' Opportunity Phase.

FIG. 58—Detailed View of the ROBUST Process' Broker Phase

FIG. 59—Phase steps, responsible parties, deliverables, and associated math for the ROBUST Process' Broker Phase.

FIG. 60—Detailed View of the ROBUST Process' Unite Phase

FIG. 61—Phase steps, responsible parties, deliverables, and associated math for the ROBUST Process' Unite Phase.

FIG. 62—Detailed View of the ROBUST Process' Stabilize Phase

FIG. 63—Phase steps, responsible parties, deliverables, and associated math for the ROBUST Process' Stabilize Phase.

FIG. 64—Detailed View of the ROBUST Process' Track Phase

FIG. 65—Phase steps, responsible parties, deliverables, and associated math for the ROBUST Process' Track Phase.

### DETAILED DESCRIPTION OF THE PREFERRED EMBODIMENT

### DR²IVE Defined

The acronym DR²IVE stands for Developing Robust Roadmaps Integrating Value Enterprises. Breaking the acronym down, each term is defined as follows:
Developing—Reinforces the fact that assessment coupled with improvement must be a never-ending process.
Robust—Focuses on reduction of variation and optimization of strategic plans within and between multiple organizations, with a particular focus on alliances and expanding the Efficient Frontier.
Roadmaps—Advocates a systematic collaboration methodology using projects as the building blocks that are networked into five-year Robust Roadmaps with measurable results.
Integrating—Promotes the use of the Robust Roadmaps as the basis for strategic collaboration internally between divisions and business units, as well as externally between alliances, mergers, acquisitions and other partners.
Value—Reduces the scope to core enterprises that add value from the customer's viewpoint and focuses the organizations engaged on optimizing their Efficient Frontier through planning for the collaborative Robust Horizon.
Enterprises—Defines organizations that have established processes that integrate their businesses and proactively manage their strategic plans through Robust Roadmaps focused on the Robust Horizon.

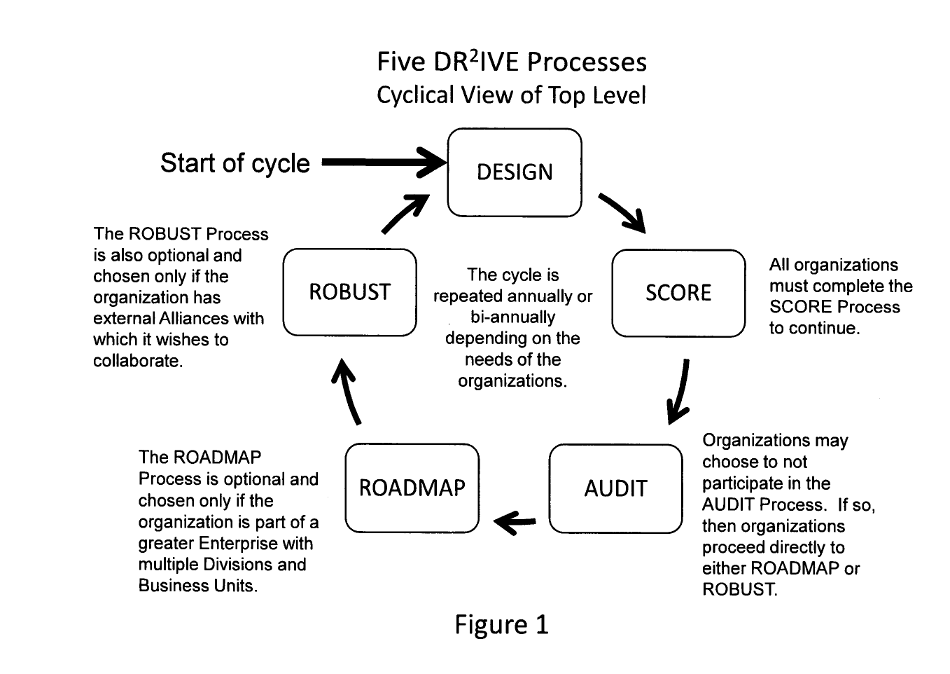

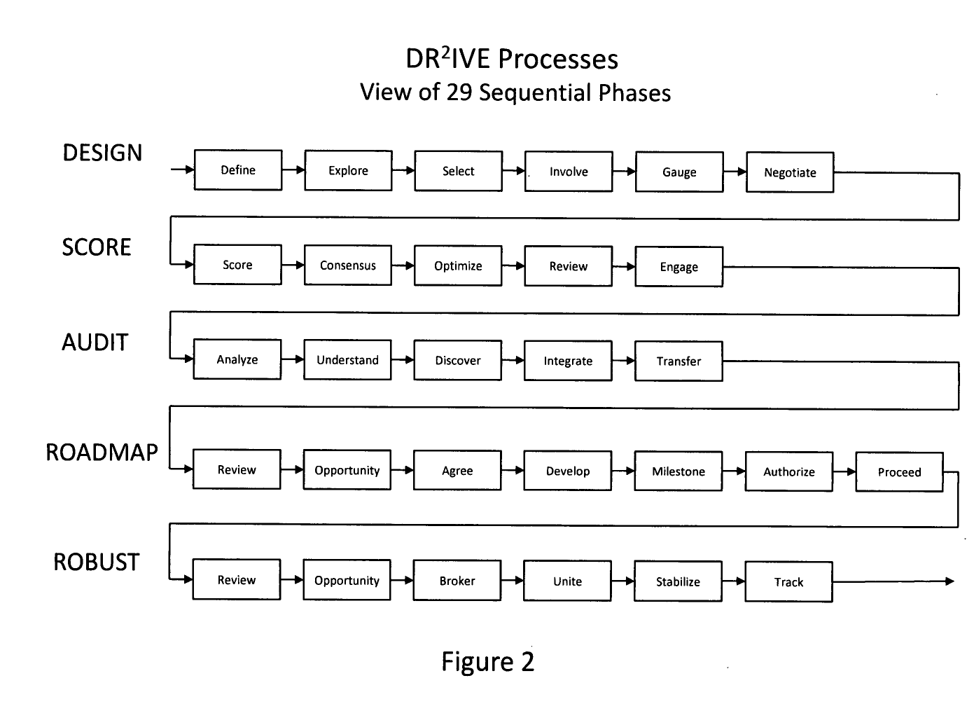

DR²IVE consists of five core processes. Each process has anywhere from five to seven phases, for a total of twenty-nine distinct phases. All of the processes have collaborative discussions as the second phase that lead to collaborative results in the subsequent phases. All of the processes may be accomplished online in a virtual environment or face-to-face traditional meetings. The five processes with the phases are shown in FIG. 1 and 2.

### Goal of DR²IVE

The primary goal of DR²IVE is to collectively expand each organization's Efficient Frontier to yield greater returns using the same (or less) resources than would have normally been used on a lesser Efficient Frontier. This expansion is accomplished through enabling professionals to create actionable Robust Roadmaps that coordinate and justify collaboration opportunities among departments, divisions, business units, enterprises, alliances, mergers, acquisitions, governments and other collaborative endeavors between multiple organizations.

### Efficient Frontier

The Efficient Frontier, as described above, is a model by which project portfolios can be evaluated and selected for optimal impact. The Efficient Frontier defines a curve along which the best possible combinations of project portfolios lie.

To select the optimal project portfolio, the organization must select projects such that the combined portfolio is on or near the Efficient Frontier. Portfolios comprised of projects along the curve are said to be efficient because the company is getting the most value from the available resources. The fundamental flaw with how the Efficient Frontier is utilized within industry is the assumption that the curve cannot be expanded. The methodology contained herein ensures such expansion. DR²IVE is a process for expanding the Efficient Frontier upward to yield higher returns for project portfolios than is possible with conventional approaches.

### Frontier Expansion

DR²IVE expands the Efficient Frontier in two ways:
1. Increasing the return on existing project proposals through organizational sharing and synergies to reduce the costs of existing project proposals and thereby free resources to allow additional projects.
2. Increasing the quality and number of new and future project proposals by focusing on world-class capabilities, existing and future paradigm shifts, and collaborative opportunities both within the enterprise and outside with alliances.

### Robust Horizon

Robust Horizon Management (RHM) is an expansion of Project Portfolio Management (PPM). With PPM, only funded projects are added to a project portfolio. In addition, PPM is focused on limiting the number of projects in the portfolio. In contrast, RHM focuses on maximizing the number of relevant projects in both the current project portfolio and future portfolios. RHM looks ahead to marshal resources so proposed projects can be added at the right time.

### Robust Roadmaps

Robust Roadmaps are strategic plans developed collaboratively by two or more alliance organizations that integrate the organizations through projects selected against world-class capabilities. Roadmaps provide tangible project networks (roadmaps), reduced overall uncertainty, greater collaboration, and lower total costs. DR²IVE is the only methodology in the world designed to result in Robust Roadmaps.

### Paradigm Integration

Since DR²IVE incorporates the latest developments in management practice, it can be thought of as a paradigm integrator. As a paradigm integrator, DR²IVE integrates best practices in management capabilities across twenty core competencies together into a single methodology under one umbrella.

The following discussion describes the basic steps of the DR²IVE methodology:

### Design Process

This is the first of five processes within DR²IVE. The DESIGN Process has six phases based on the acronym DESIGN:
Define Phase: In this phase, a DR²IVE Initiative Champion defines the initial management model identifies internal candidate collaborative organizations, considers external candidate organizations for alliances and seeks the engagement of these candidates.
Explore Phase: Professionals from organizations selected by the Initiative Champion come together to determine how their organizations can collaboratively leverage DR²IVE for competitive advantage.
Select Phase: Each organization formally selects their DR²IVE Model and planned engagements.
Involve Phase: Once engagements are set in the Select Phase, each organization assigns managers to the engagements in the Involve Phase.
Gauge Phase: Organizations that have selected multiple organization engagements coordinate with each other to set specific dates when the engagements will begin and end.
Negotiate Phase: Collaboration Charters are created for multiple organization engagements that summarize the following: type of engagement (from the Select Phase), resource commitments (from Involve Phase), engagement milestone schedule (from Gauge Phase), project return sharing guidelines, and authorizations from the corresponding Champions.

### Score Process

The SCORE Process is designed to assess organizations on one or more DR²IVE World-Class Management Step Charts. The goal of organizations engaging in the SCORE Process is to maximize the organization's Efficient Frontier. The phases of the SCORE process are described below:
Score: Scores are assigned to attributes in World-Class Management Step Charts by a DRIVER, a professional certified to assess the step charts.
Consensus: Reviewers rate attribute scores within the World-Class Management Step Charts. Reviewers cannot change the scores, but they can influence the final attribute scores given by the DRIVER in the Optimize Phase.
Optimize: Reviewers discuss attribute scores with low consensus ratings. The goal is to optimize the attribute scores to reflect the results of the consensus and follow-on discussions.
Review: The DRIVER publishes a Chart Report complete with Chart Score, summary tables, and charts.
Engage: The Score Report is published. The Score Report contains the Organization DR²IVE Score and all Chart Reports on which the organization assessed itself. The Engage Phase completes the SCORE Process, allowing the organization to pass the SCORE Report to the AUDIT, ROADMAP and ROBUST Processes.

### Audit Process

The AUDIT Process is used to officially register the management capability of organizations as World-Class, Proactive, Mechanical or Clerical. Once completed, the organization will be able to declare their DR²IVE Score as official and will also be able to access comparison data as discussed in the SCORE Process.
Analyze Phase: A list of discrepancies is generated from the Unofficial Score Report. The list is called a Discrepancy Report.
Understand Phase: The Discrepancy Report attributes are the discussion topics in this phase. The objective is the resolution of as many discrepancies as possible in order to mitigate the time and cost of the Discover Phase.
Discover Phase: A Registrar plans a physical Discovery Visit to one or more facilities of the organization undergoing the AUDIT Process. The Discovery Visit is intended to provide the Registrar and the organization the opportunity to address aspects and requirements of the plan.
Integrate Phase: A new SCORE Report can be reviewed and approved by all relevant parties.
Transfer Phase: Participants who helped with the AUDIT Process will see the completed Official SCORE Report for the first time.

### The AUDIT Process assures the outside world that an organization is serious about pursuing strategies to improve its management capability for long-term success.

### Roadmap Process

The ROADMAP Process is selected by organizations to create an Enterprise (internal) Roadmap using results from the SCORE Process for the enterprise's various divisions or business units. The ROADMAP Process includes: Review, Opportunity, Agree, Develop, Milestone, Authorize and Proceed. The goal of organizations engaging in the ROADMAP Process is to maximize the organization's Enterprise Frontier
Review Phase: Opportunities are generated by comparing capabilities and project priorities for their attributes, then ranked using an Opportunity Index. The comparisons are summarized, the opportunities are reviewed, and placed into one of three categories: Collaborative Project Opportunity (CPO); Not Collaborative Project (NCP); and/or Dead Opportunity on Arrival (DOA)
Opportunity Phase: Attributes selected in the Review Phase become discussions in this phase. The Opportunity Phase employs a Project Value Index (PVI). The PVI is the tool for ranking projects for selection within the ROADMAP and ROBUST Processes. The PVI accounts for both the quantitative and qualitative returns from projects.
Agree Phase: An Agreement Report is generated listing the projects that were set-up in the Opportunity Phase by their Project Value Index (PVI) rank.
Develop Phase: The project proposals that have been given charters are now loaded into a Project Portfolio Management (PPM) system.
Milestone Phase: In this phase two types of milestones are added. The first are Program Management Milestones that identify significant points in roadmaps for groups of projects. These are called Collaborative Milestones in the Collaborative Roadmap. The second type of milestone is the Roadmap Placeholder Milestone. Placeholder Milestones protect internal programs from external entities by revealing only information required for the proper sequencing of projects.
Authorize Phase: Up to this point, the Enterprise Roadmap has not been fully authorized by upper management. Some explicit approval must have bee granted through acceptance of the outputs of the processes and phases. Although the SCORE Report, Registrar Report, Opportunity Report and Agreement Report should have been submitted to management, the Authorize Phase may be the first viewing of the projects networked together in a roadmap.
Proceed Phase: At this point, each organization has the option to load the projects from the roadmap into their organization's information technology system.
   The ROADMAP Process enables strategic planners to create an Enterprise Roadmap using results from the SCORE Process for the enterprise's various divisions or business units. By identifying opportunities to maximize an enterprise's capability strengths, the enterprise can leverage its own knowledge and expertise to extend to the Enterprise Frontier.

However, extension to the Enterprise Frontier may be insufficient to sustain competitive advantage as organizations around the world learn to better leverage their own enterprises. The only way to assure sustainable competitive advantage is to embrace alliances. The following discusses the ROBUST Process, which is designed to result in Alliance Roadmaps. Alliance Roadmaps complete the roadmap required to develop Robust Roadmaps.

### Robust Process

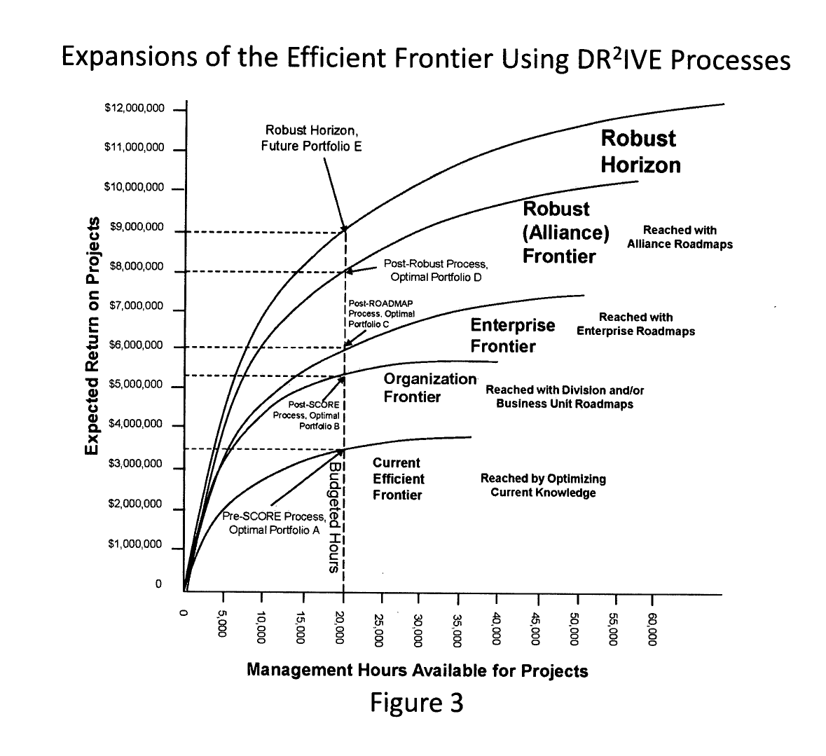

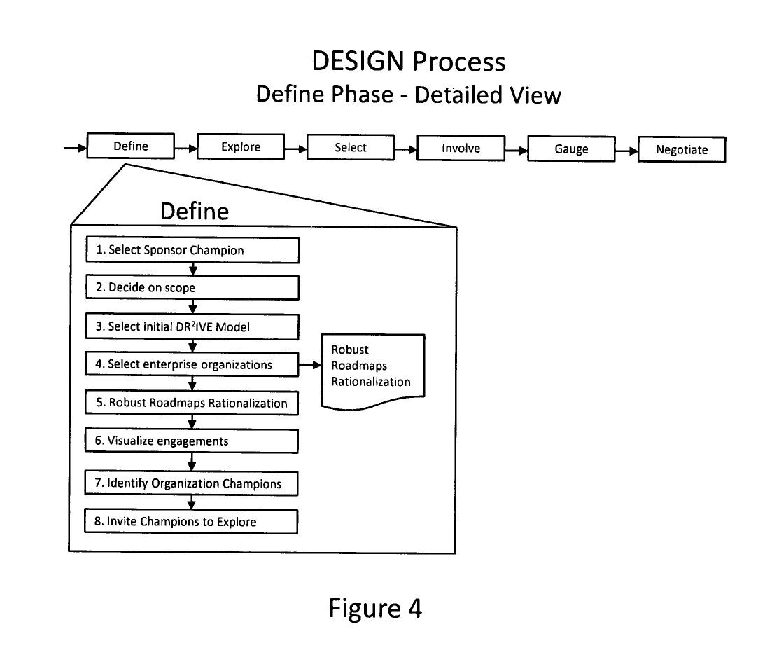

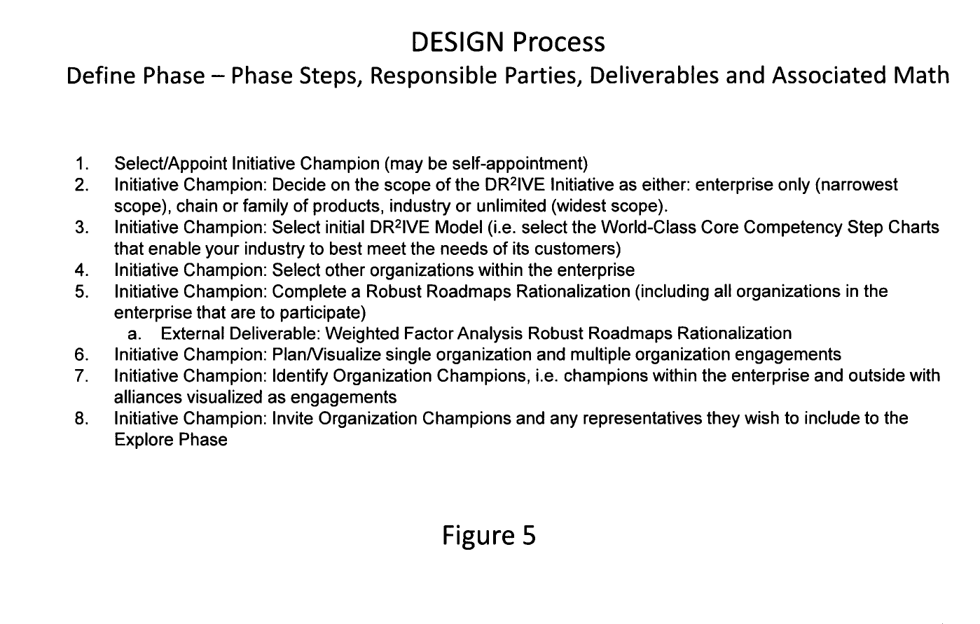

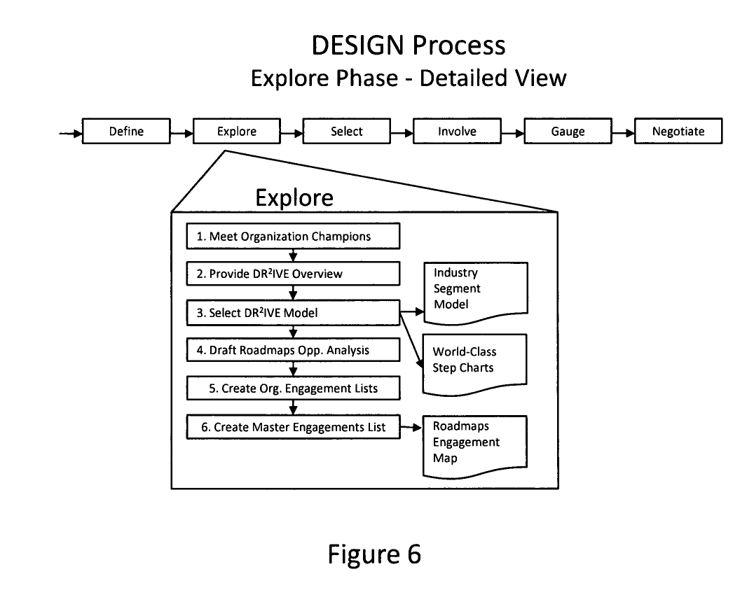

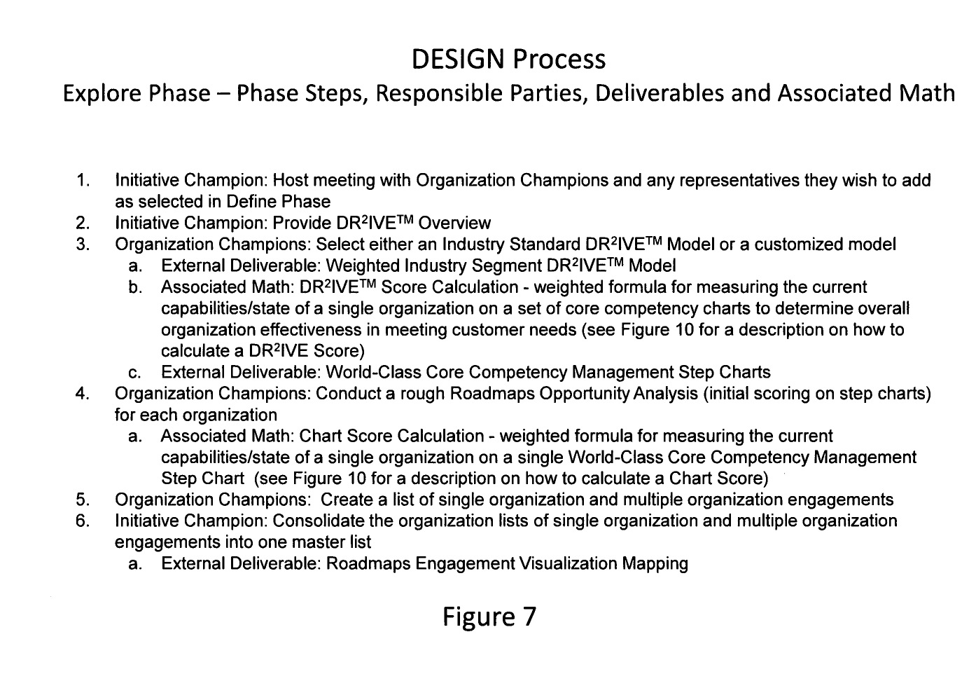

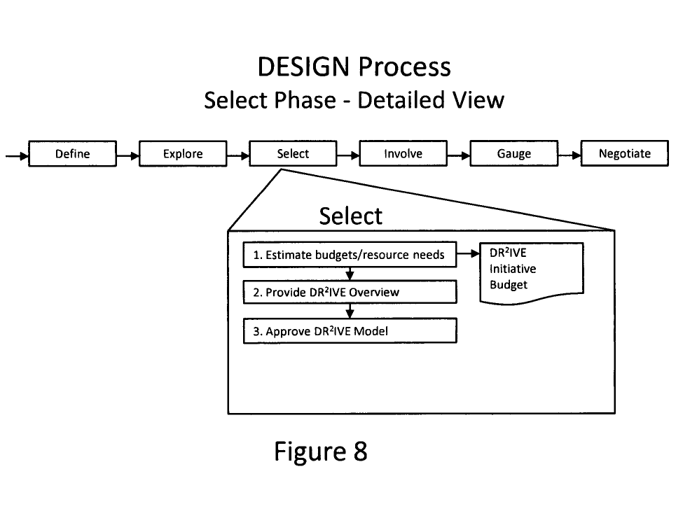

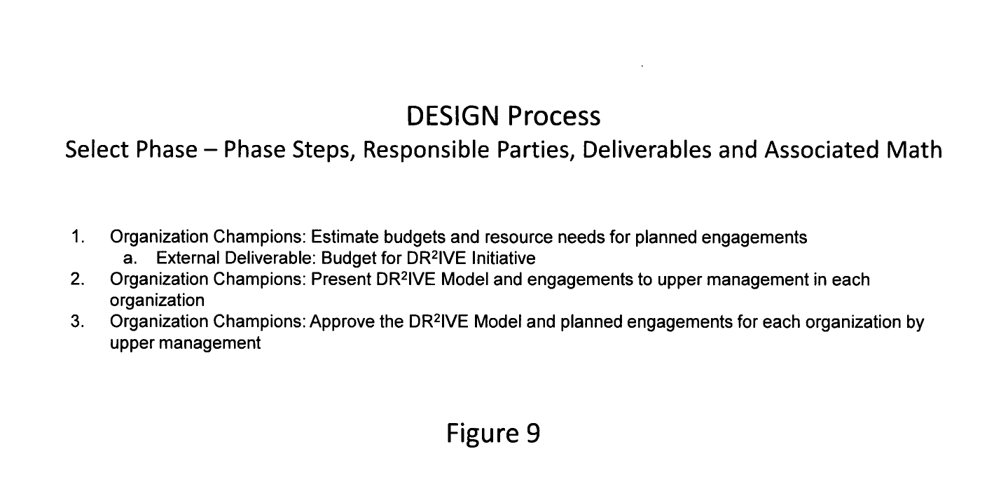

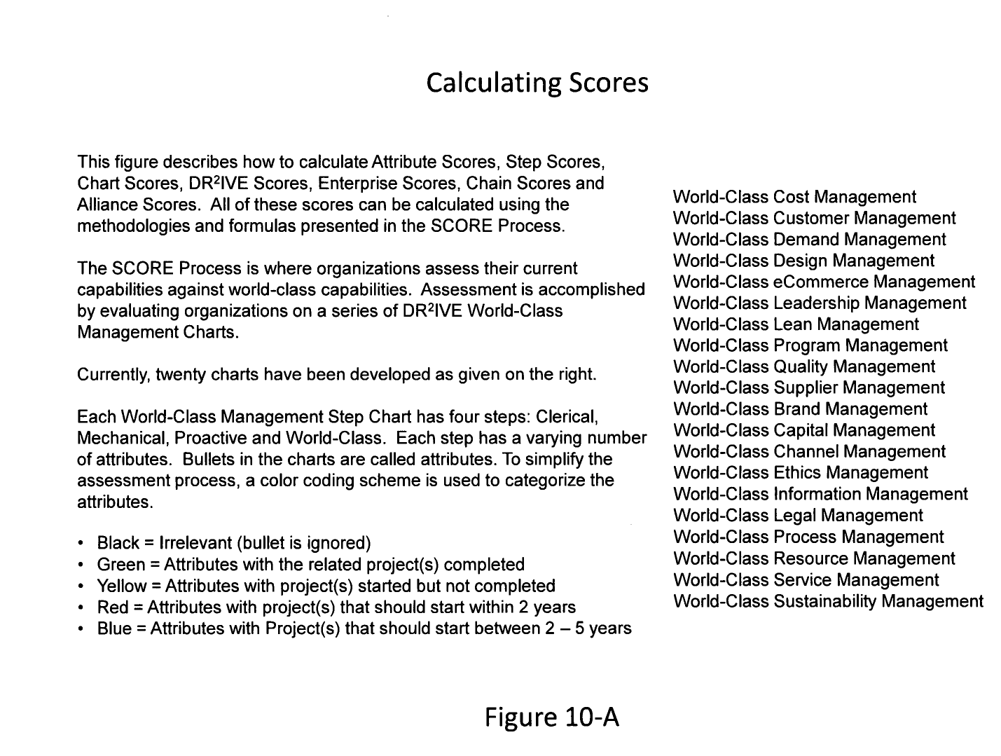

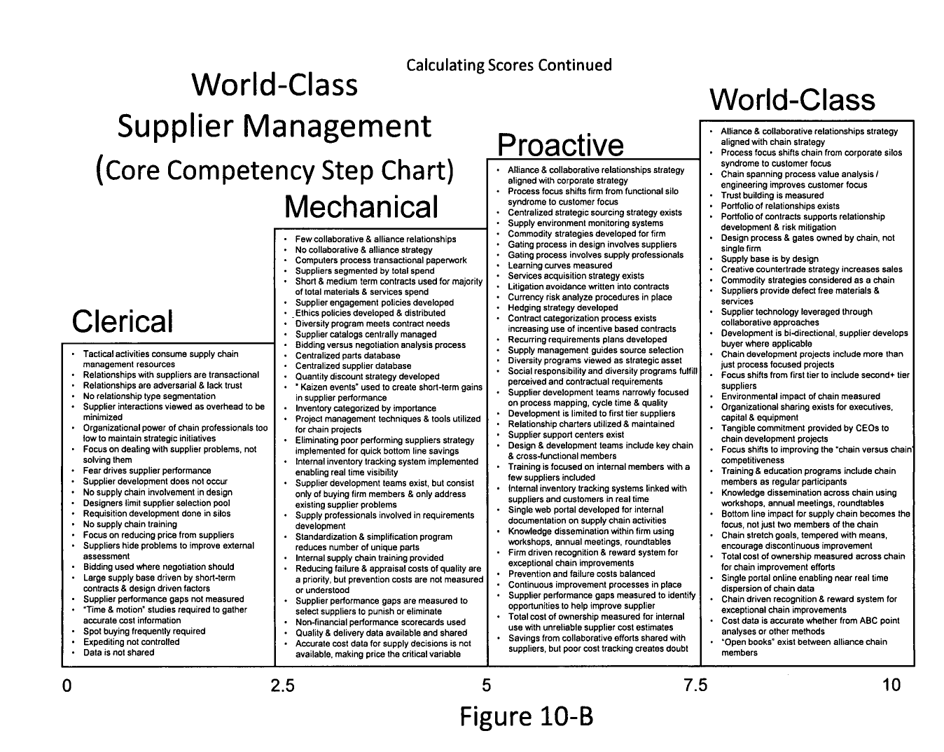

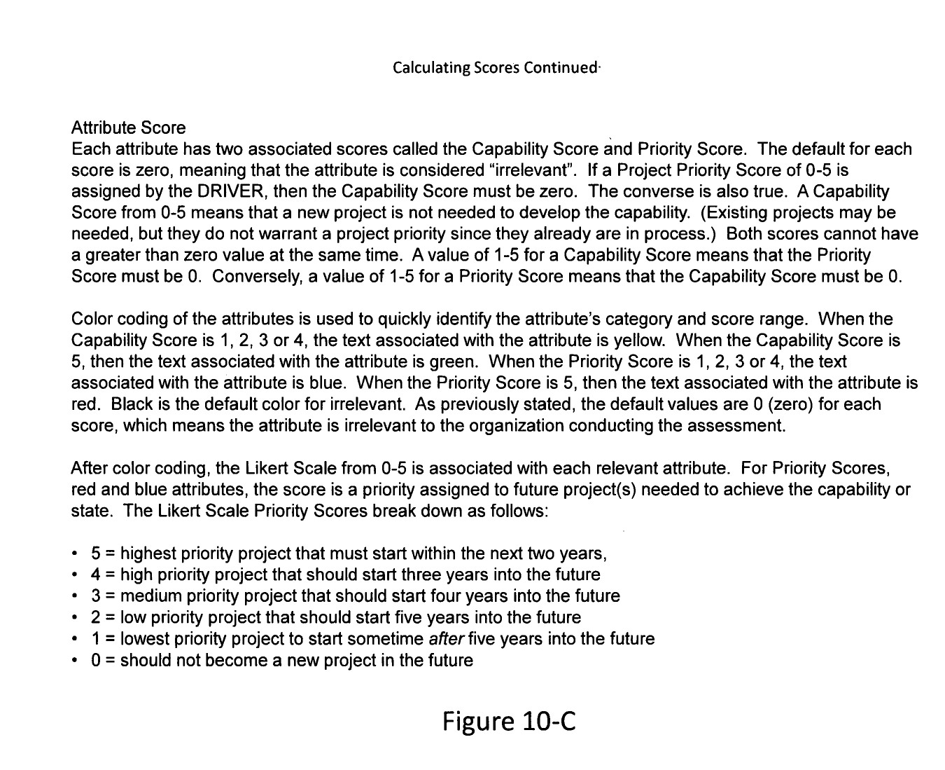

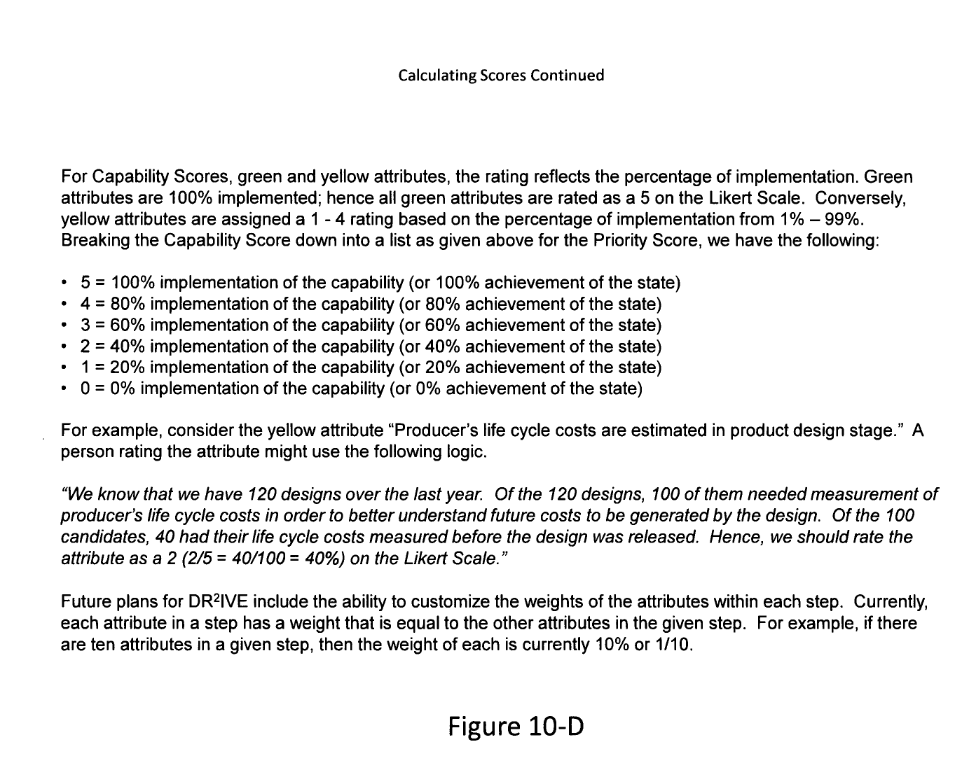

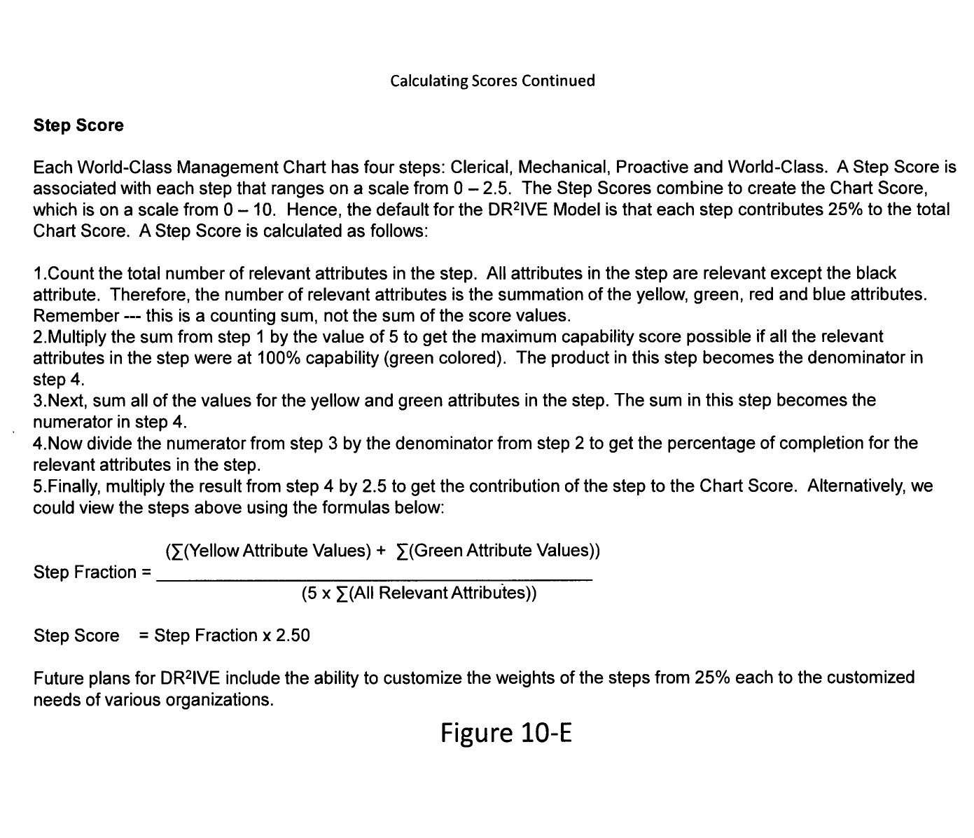

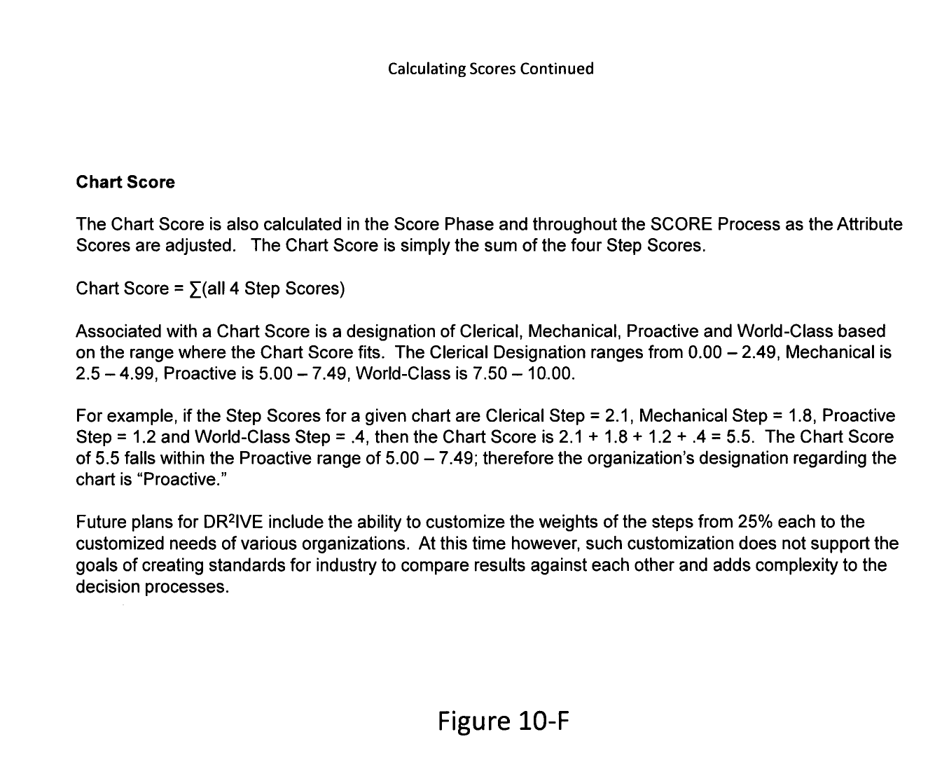

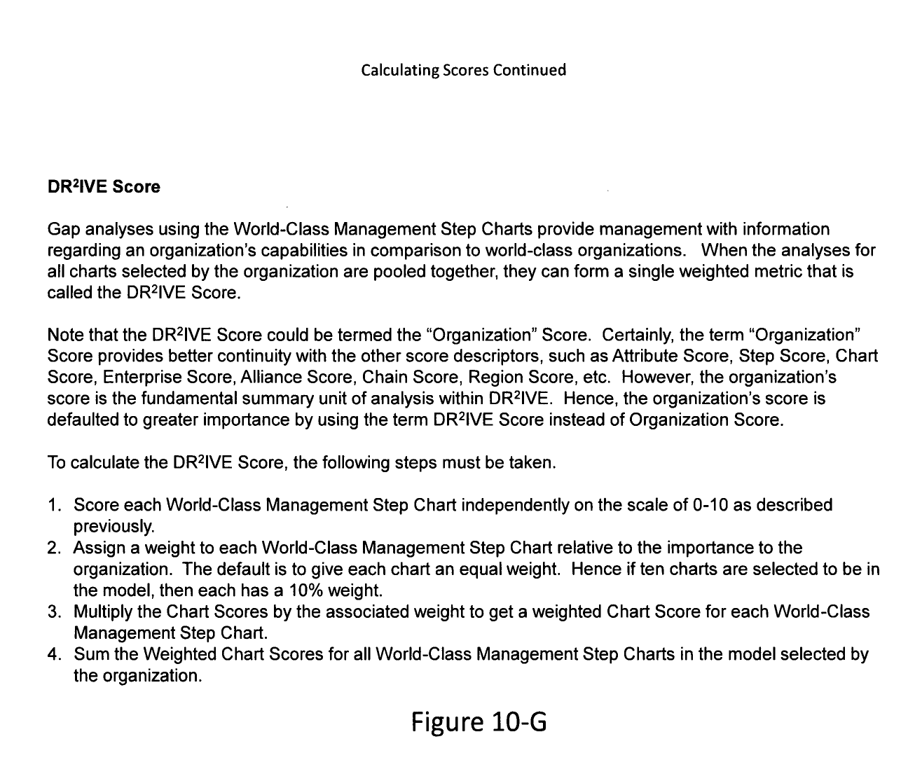

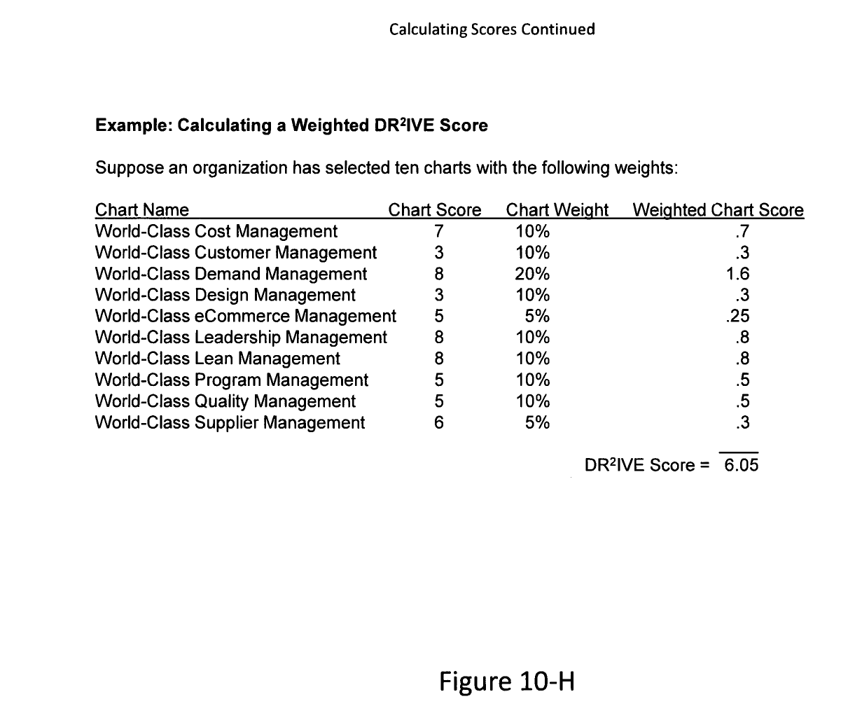

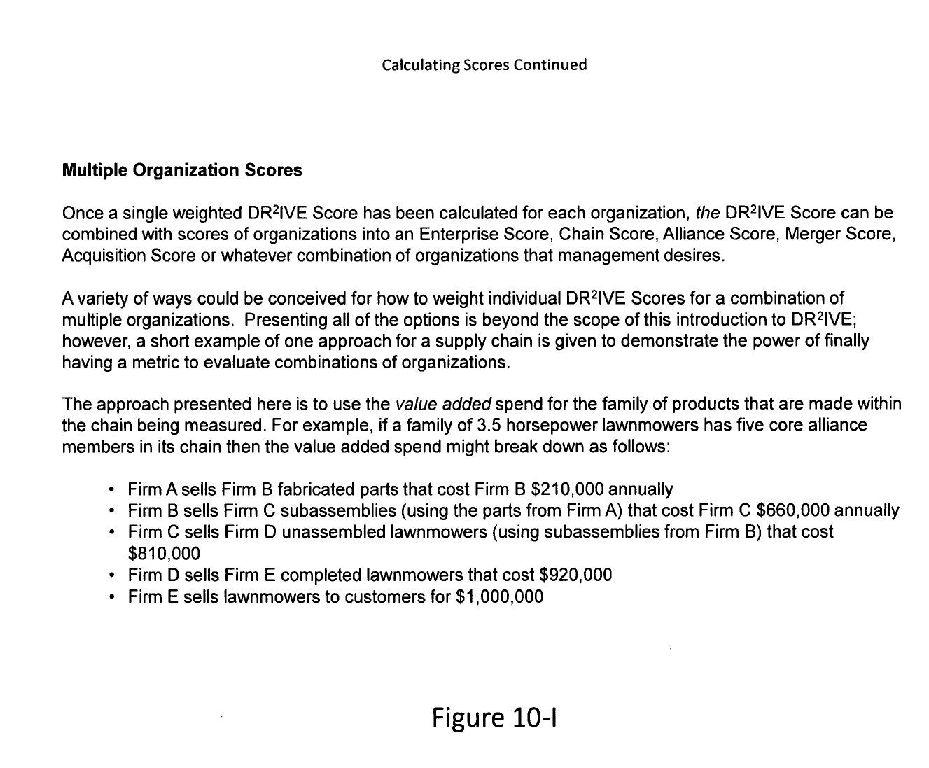

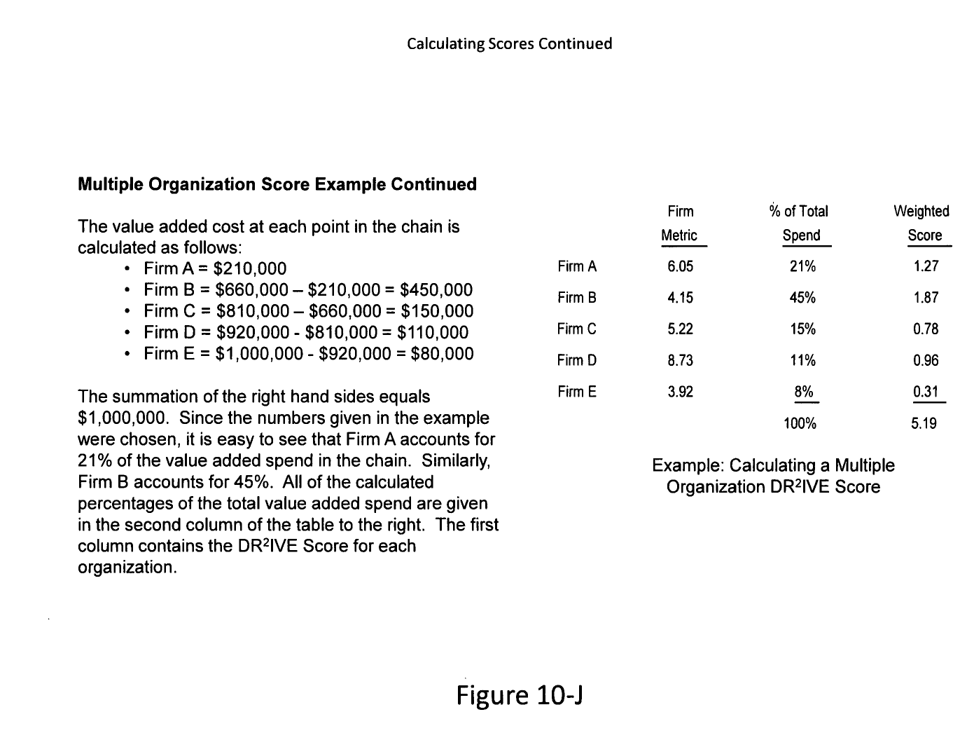

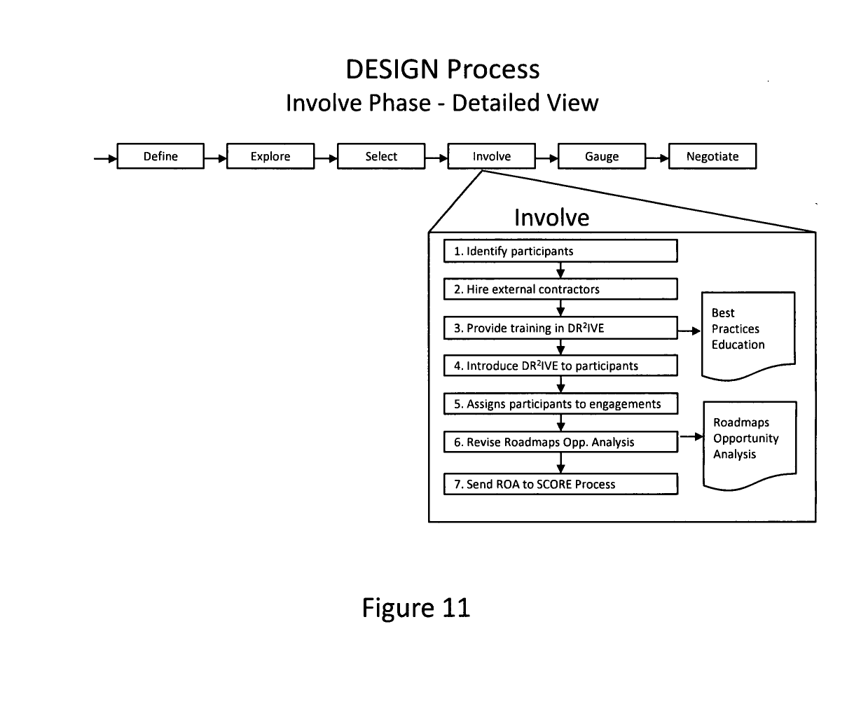

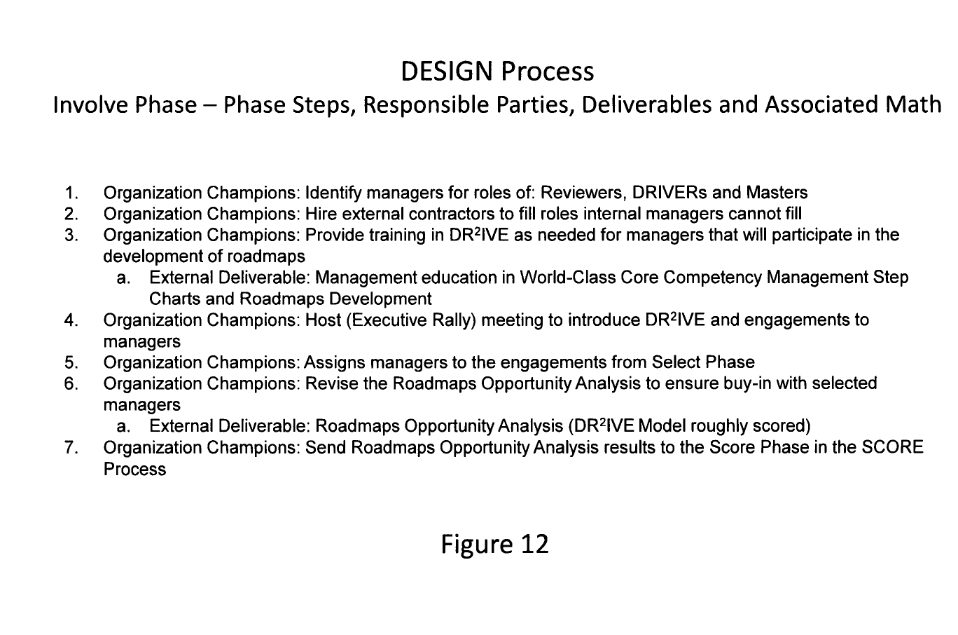

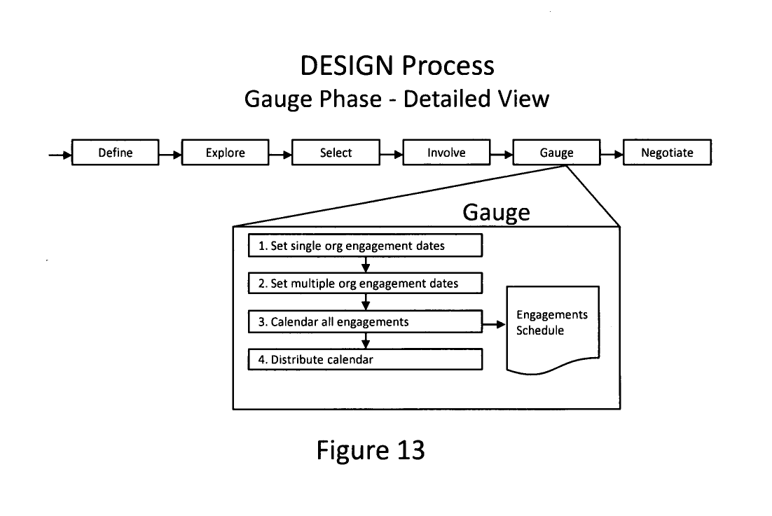

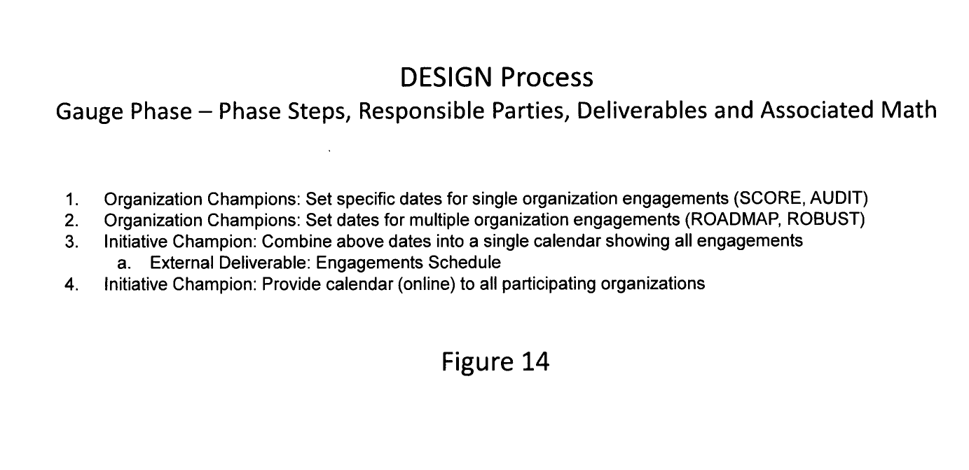

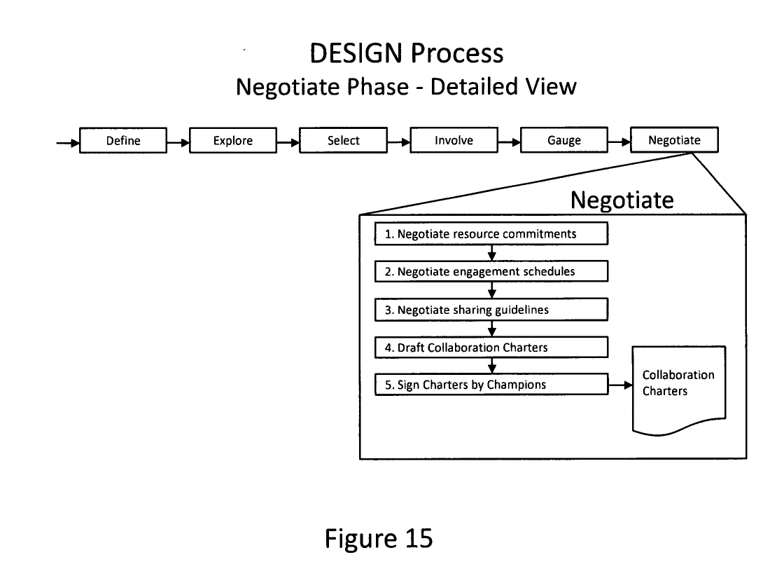

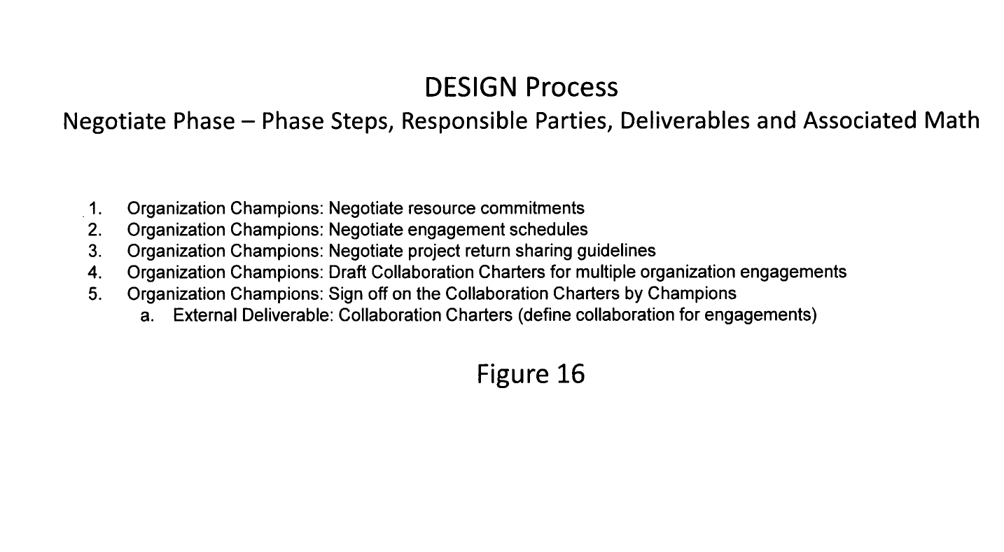

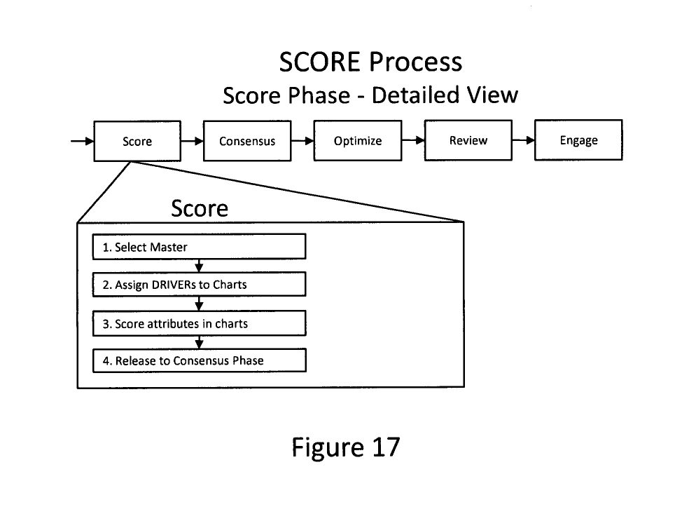

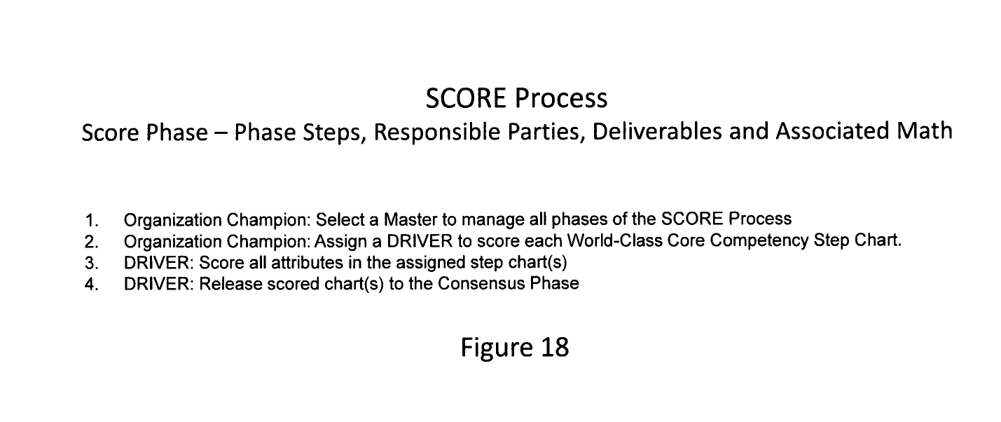

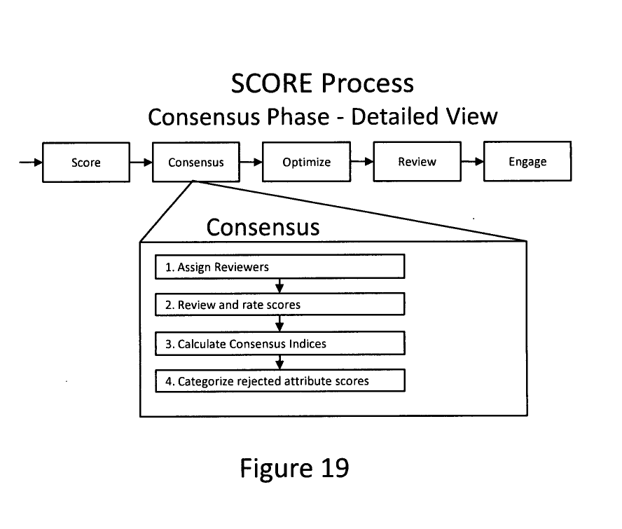

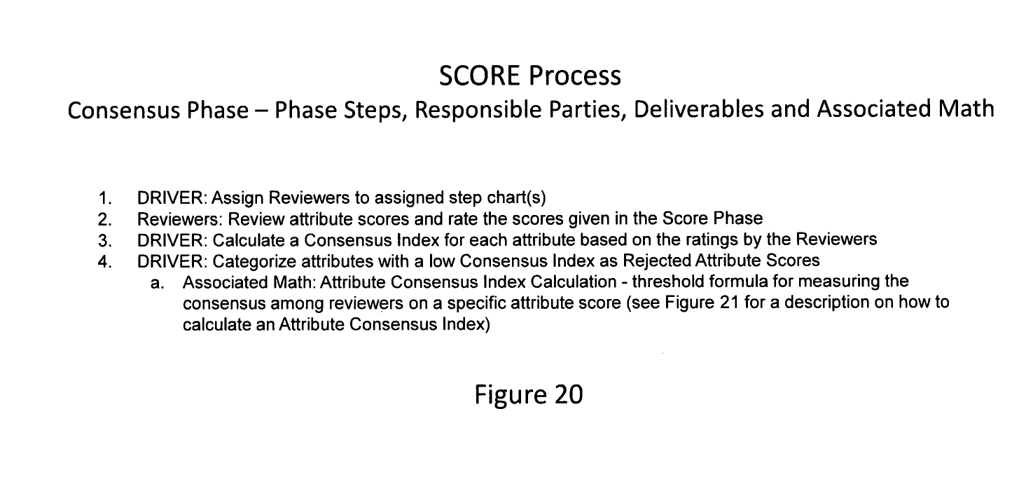

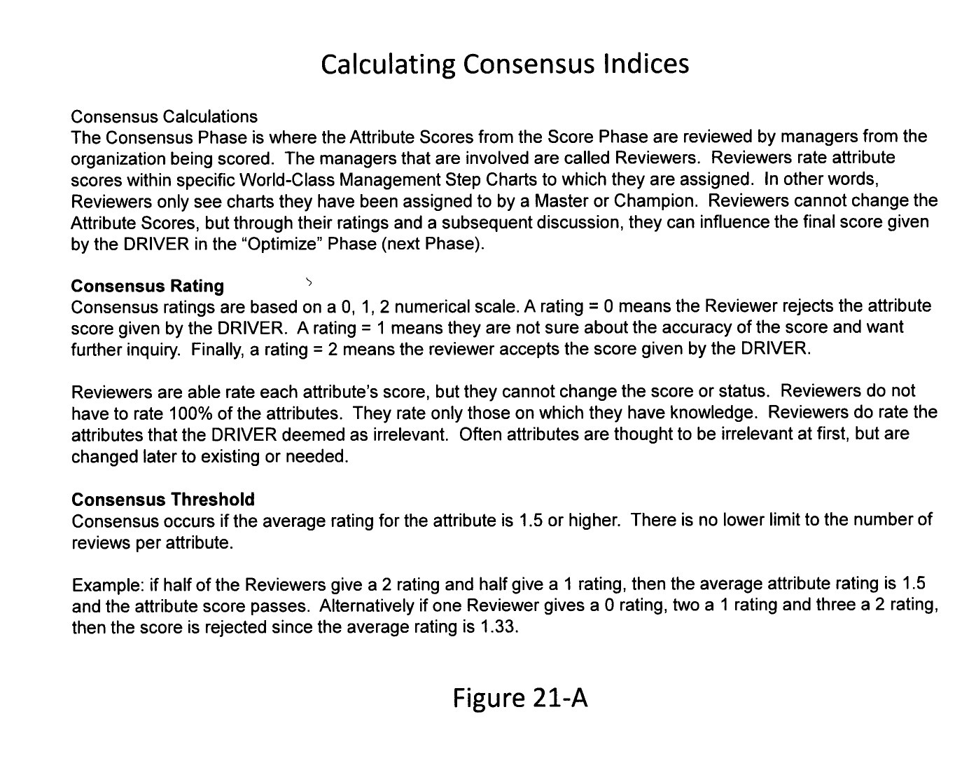

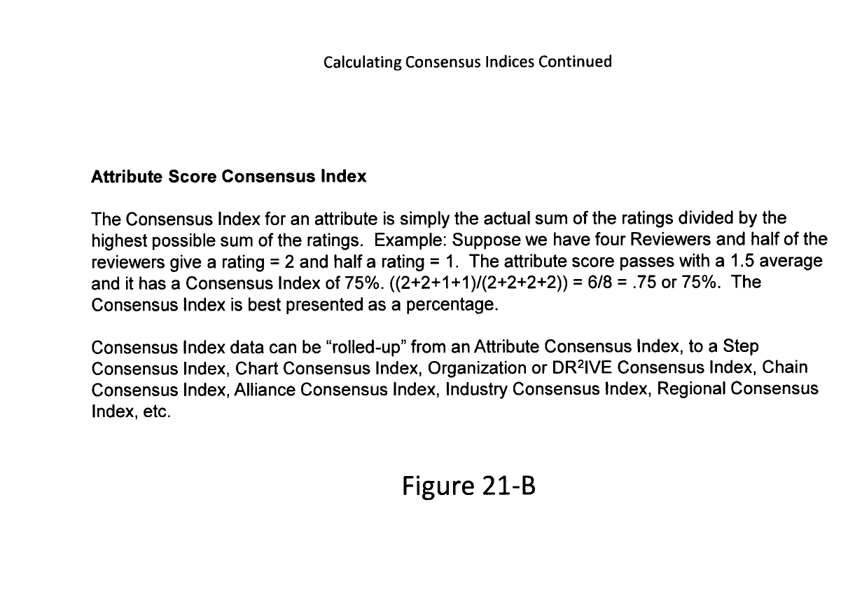

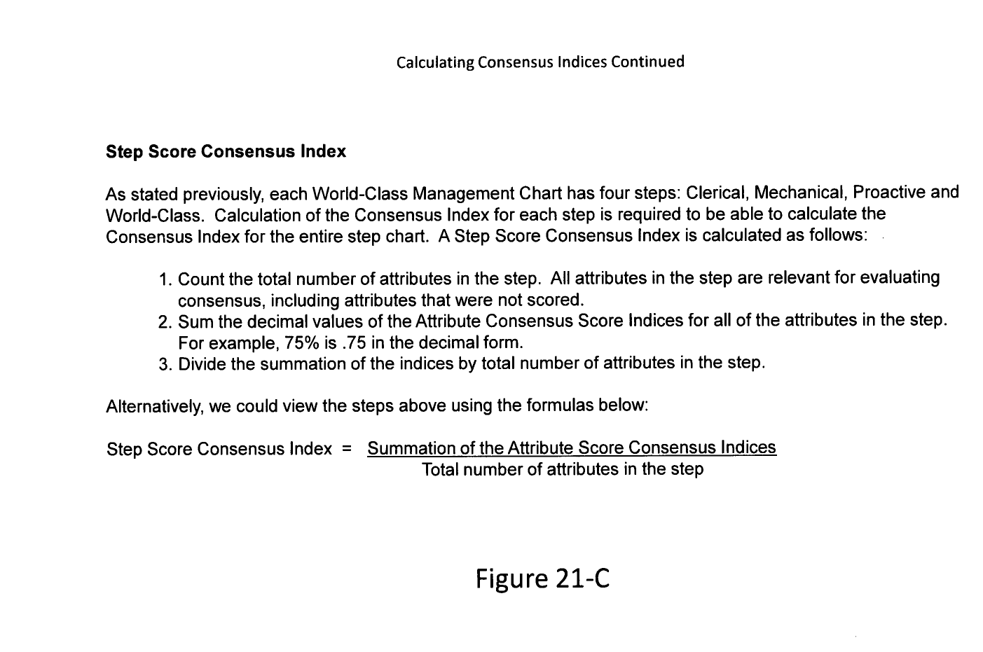

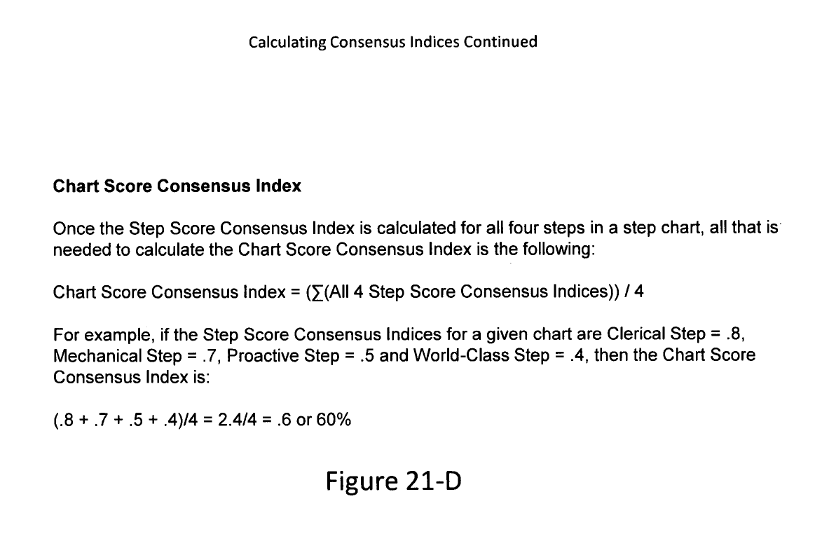

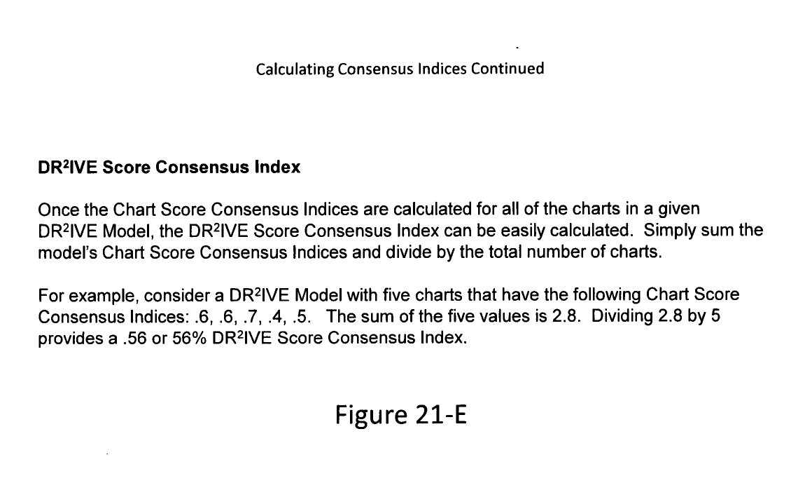

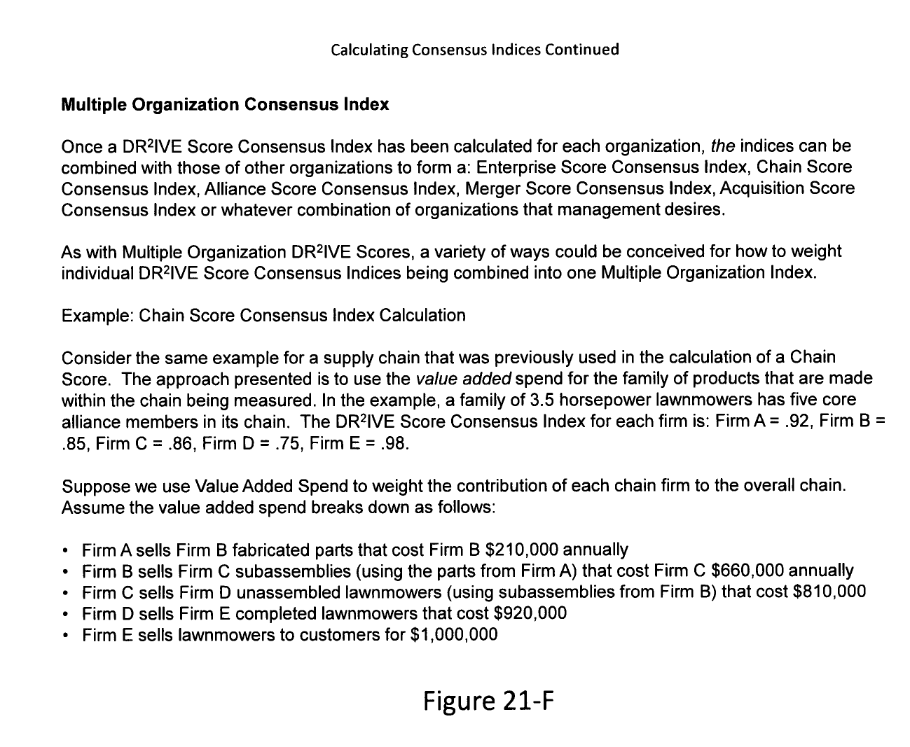

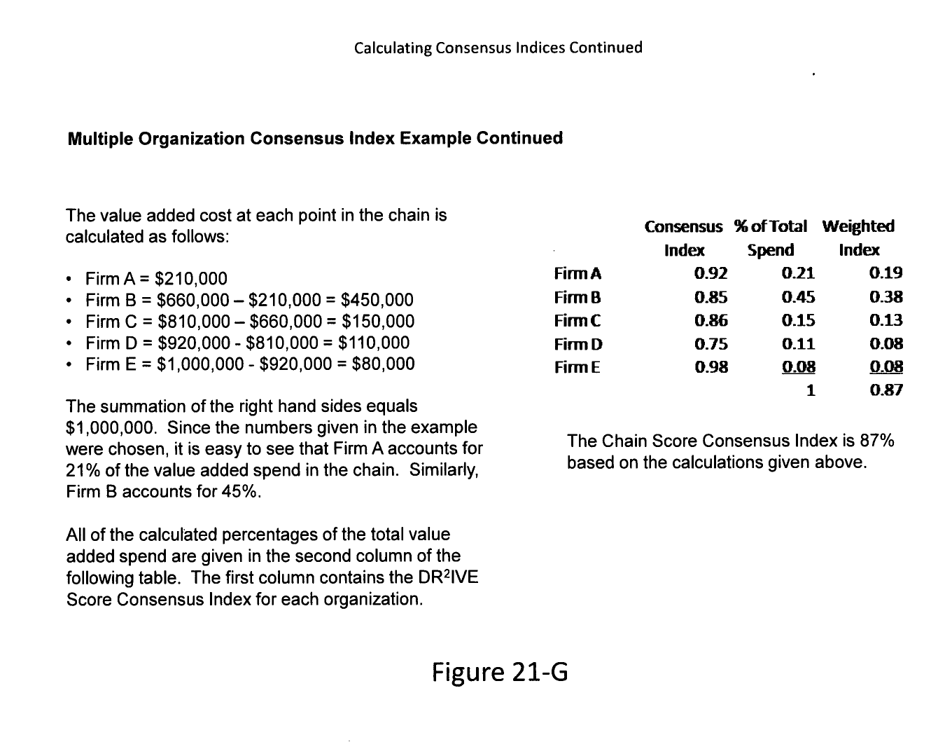

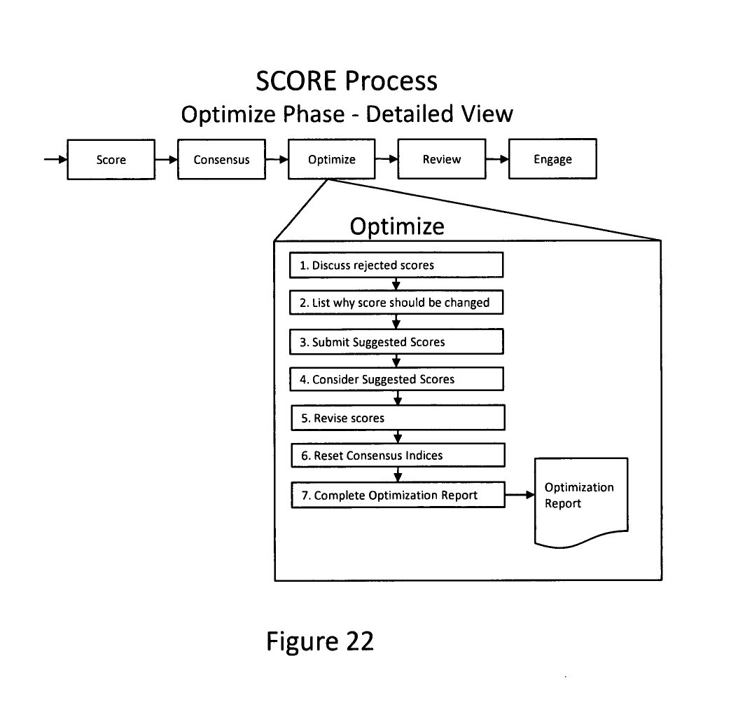

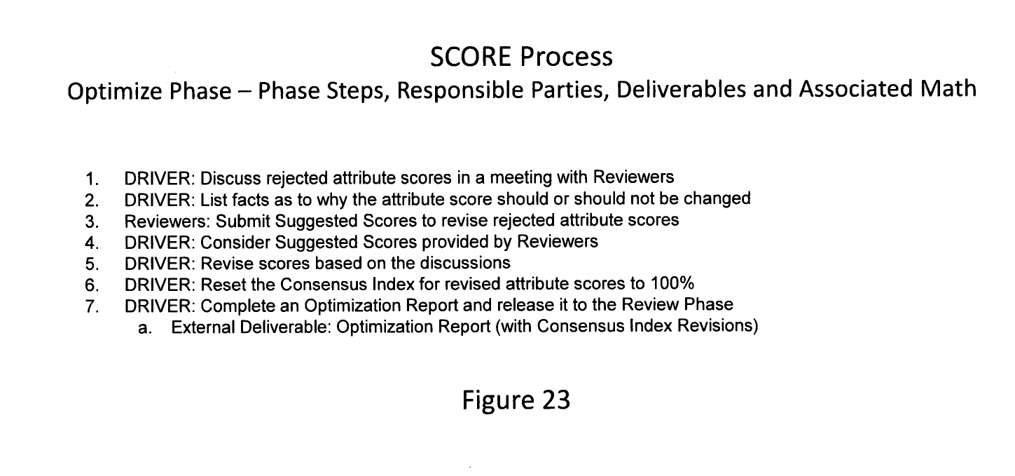

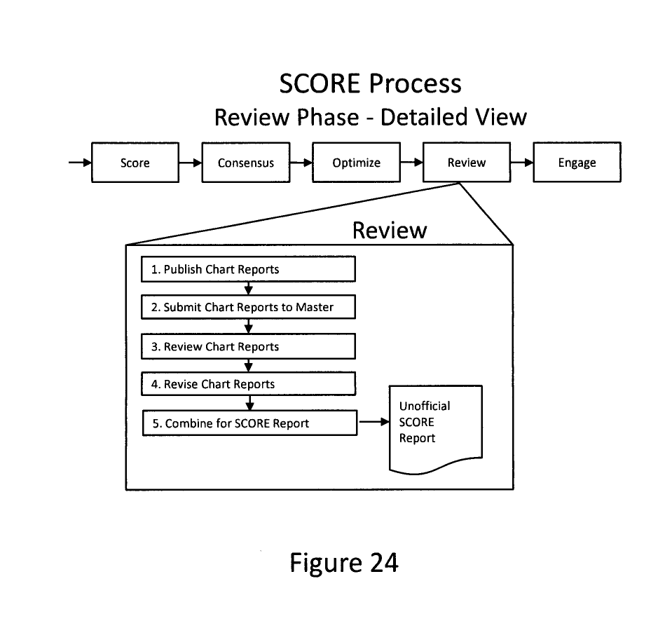

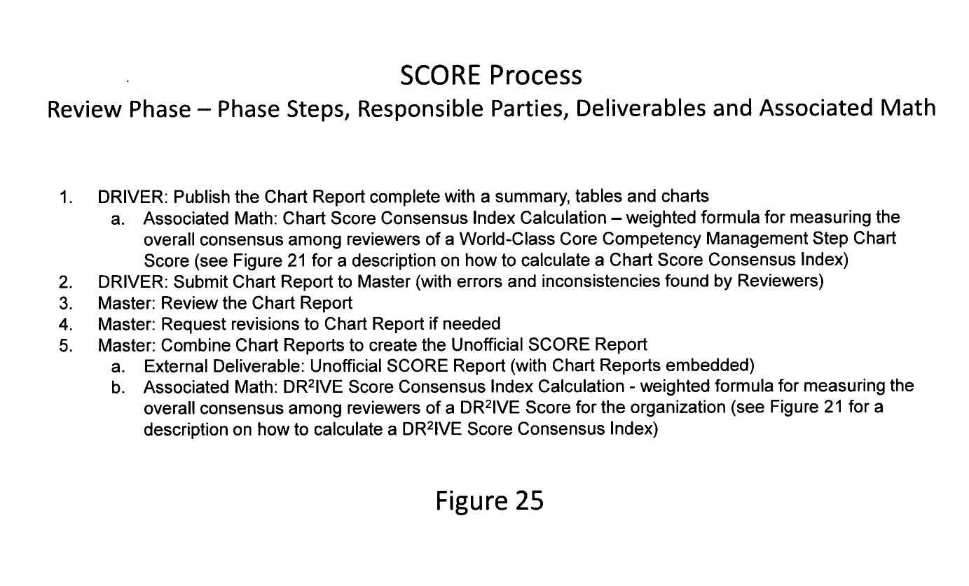

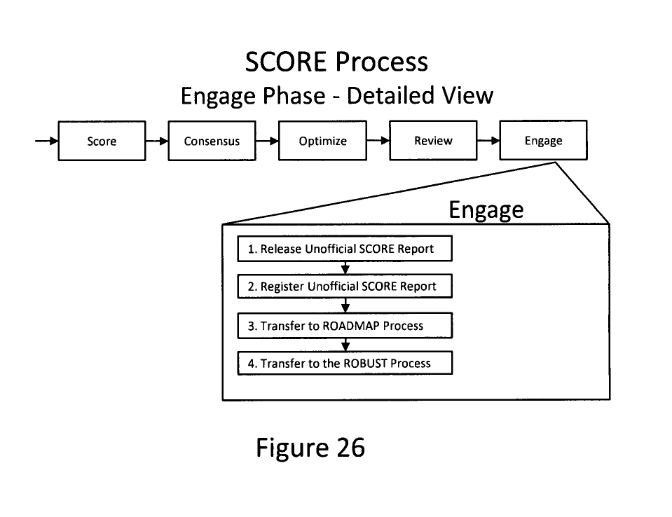

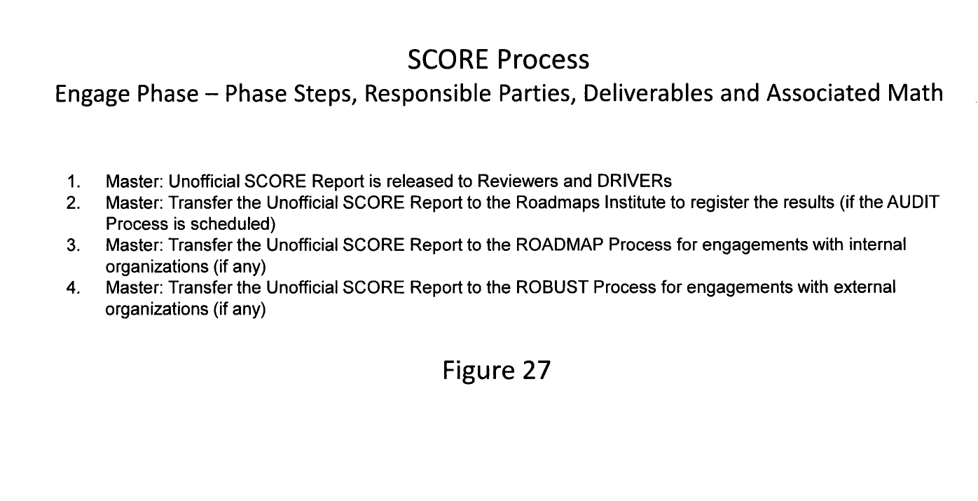

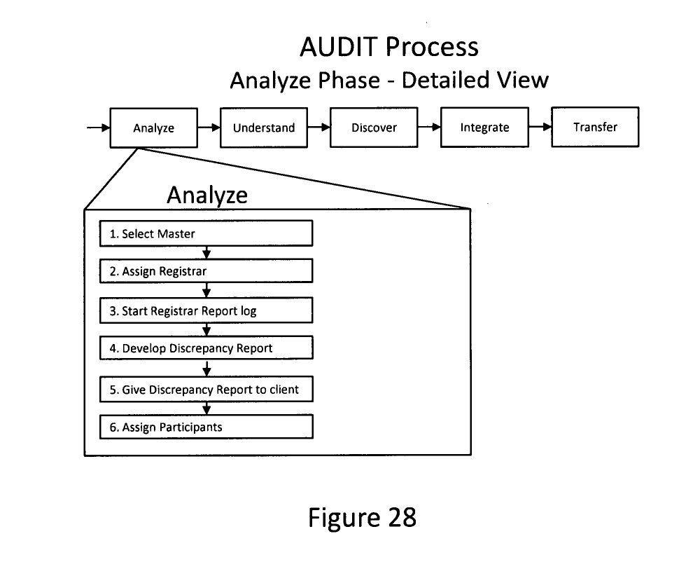

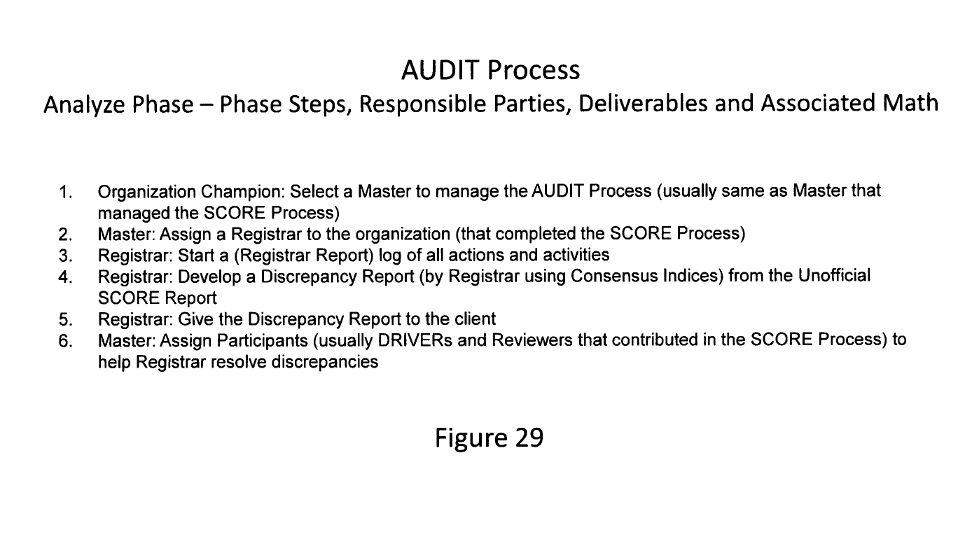

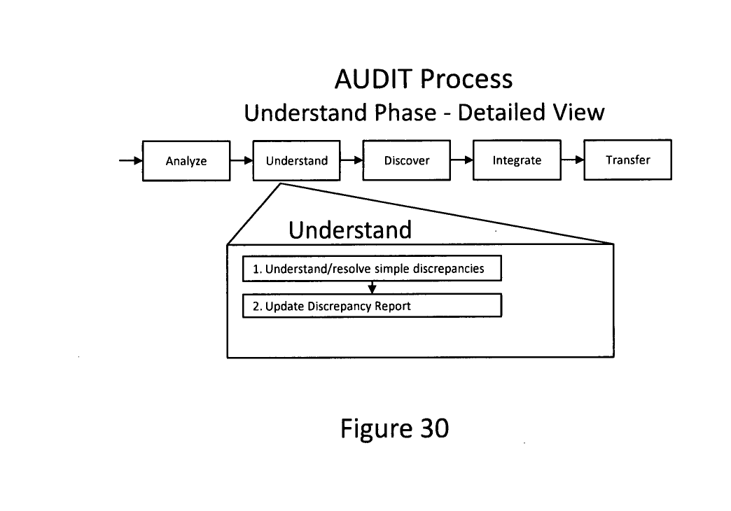

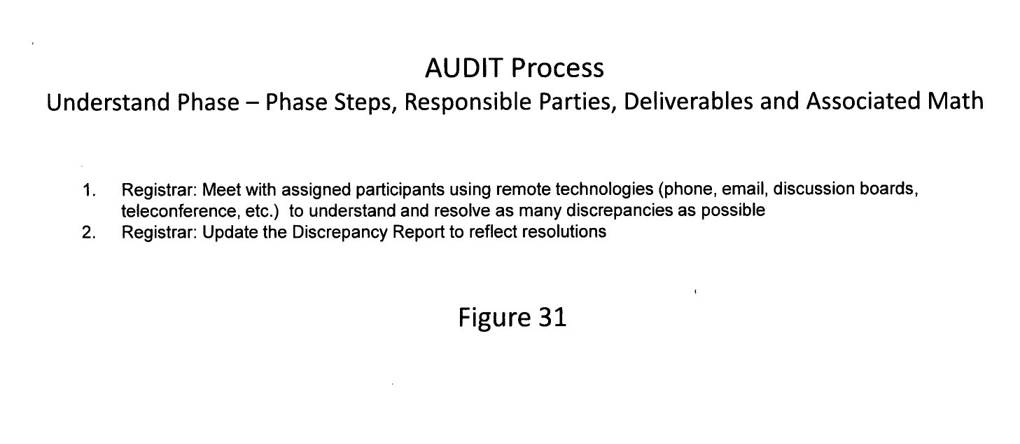

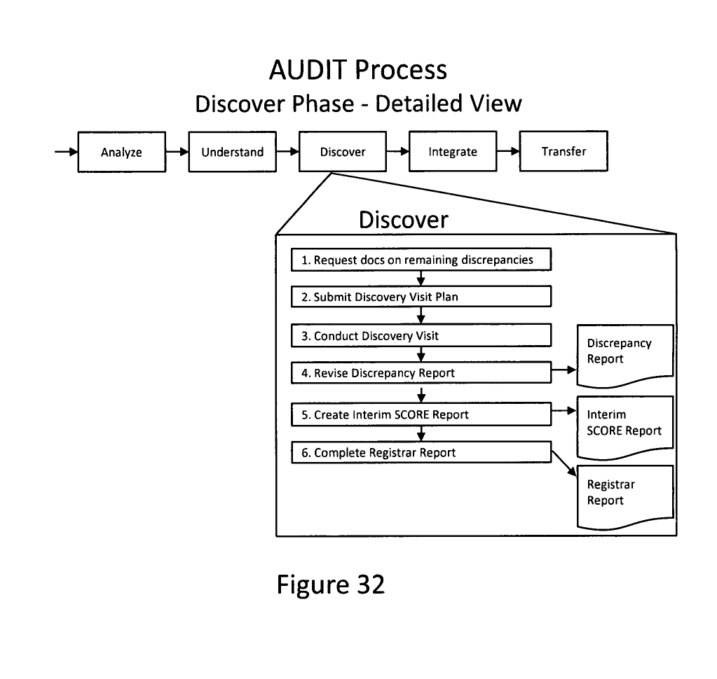

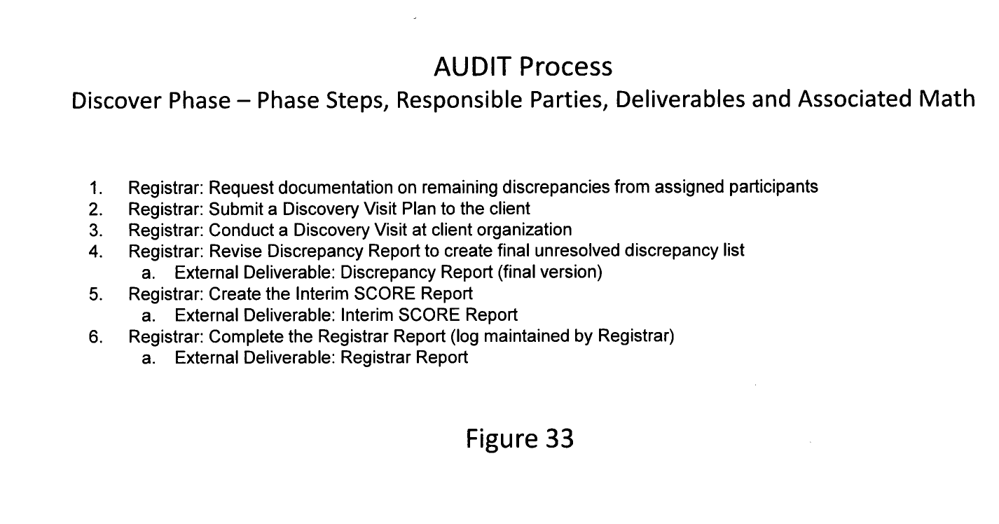

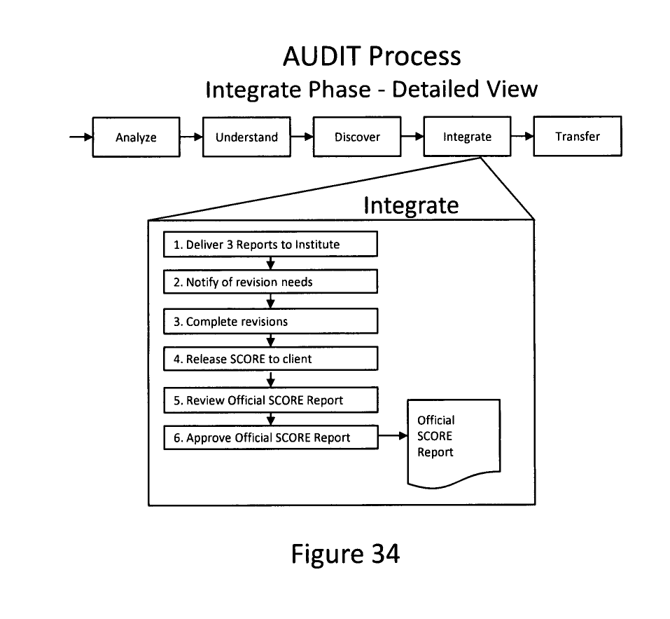

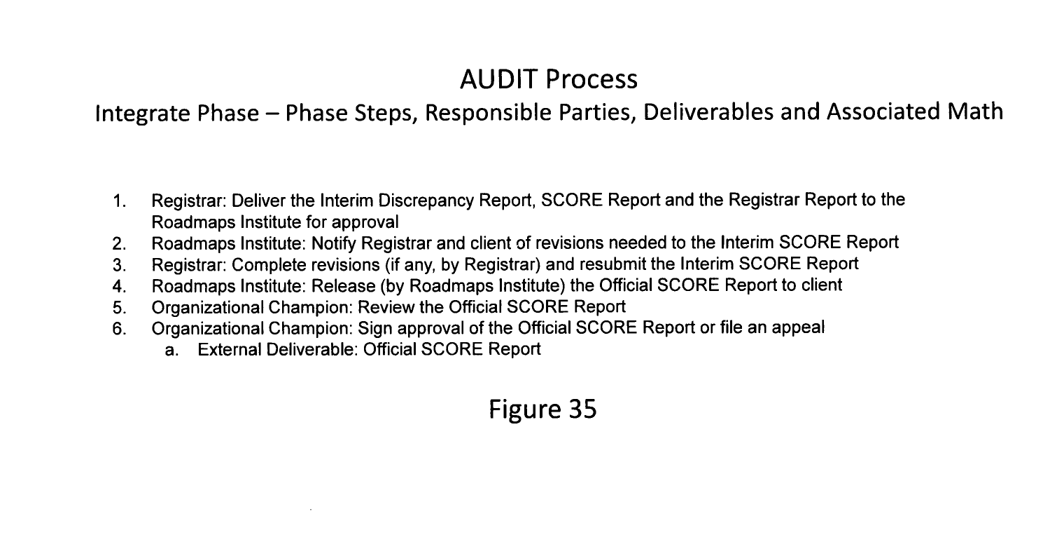

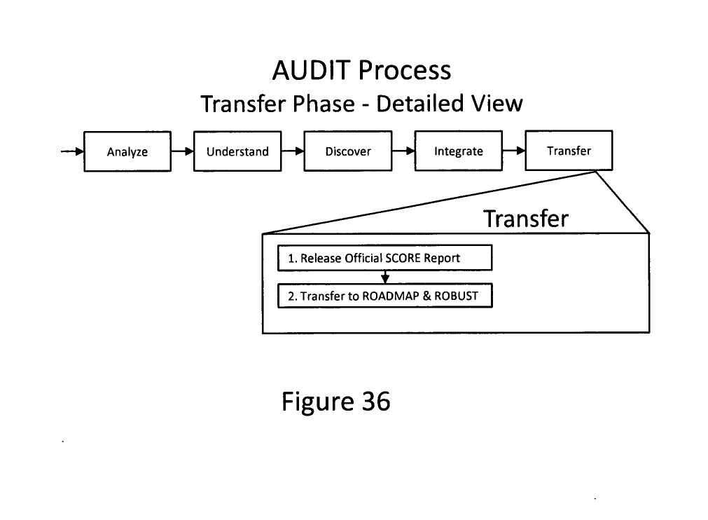

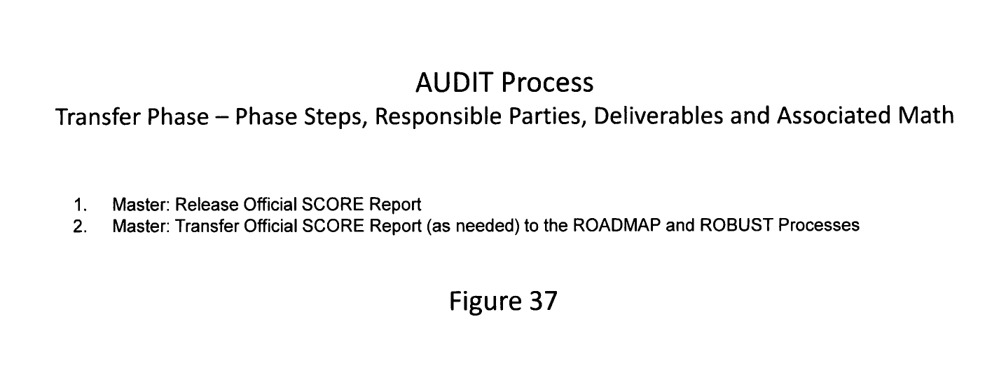

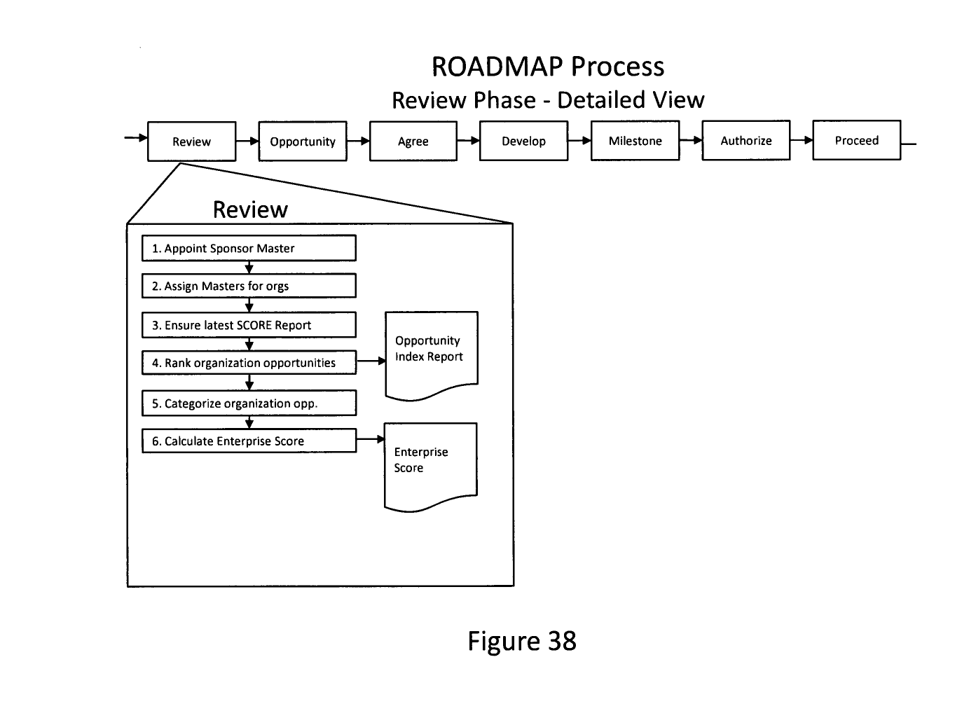

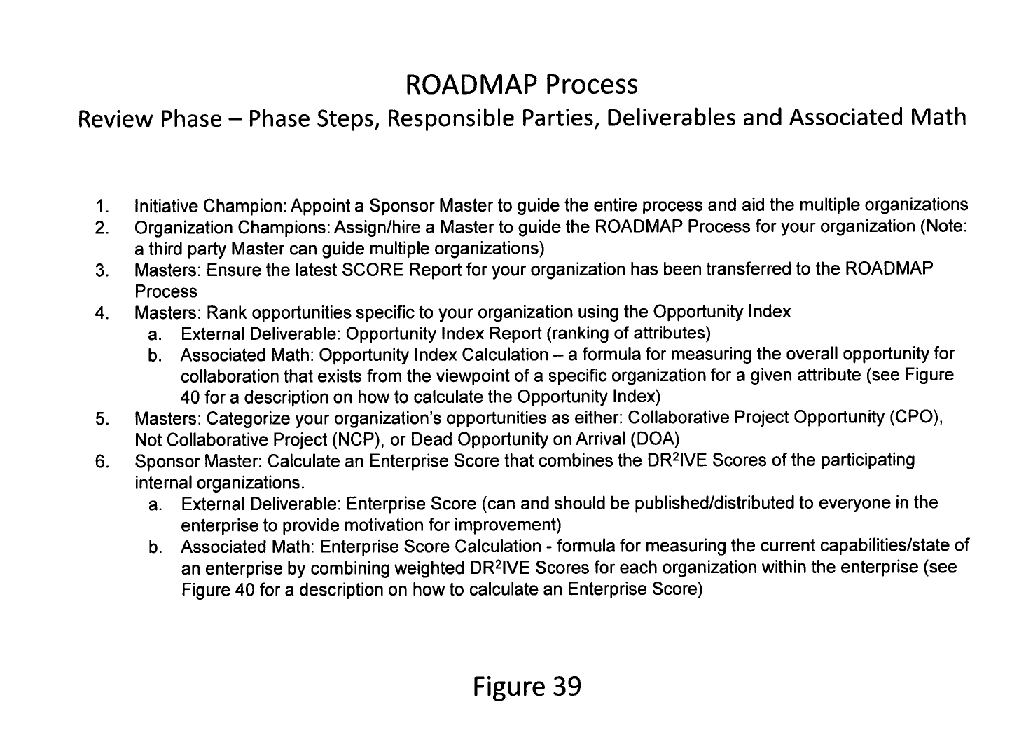

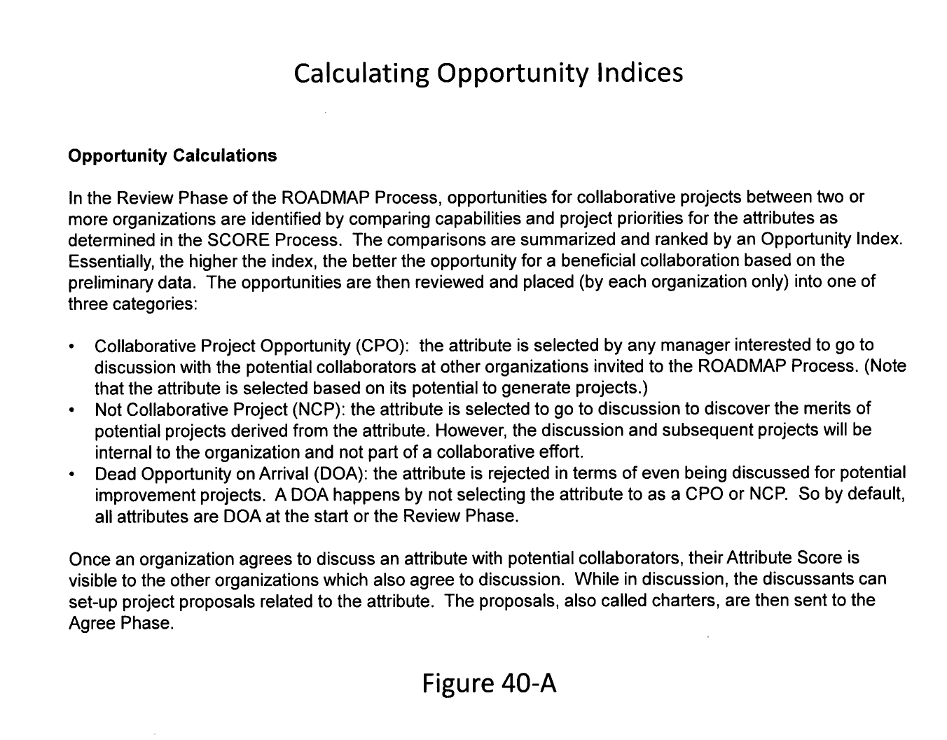

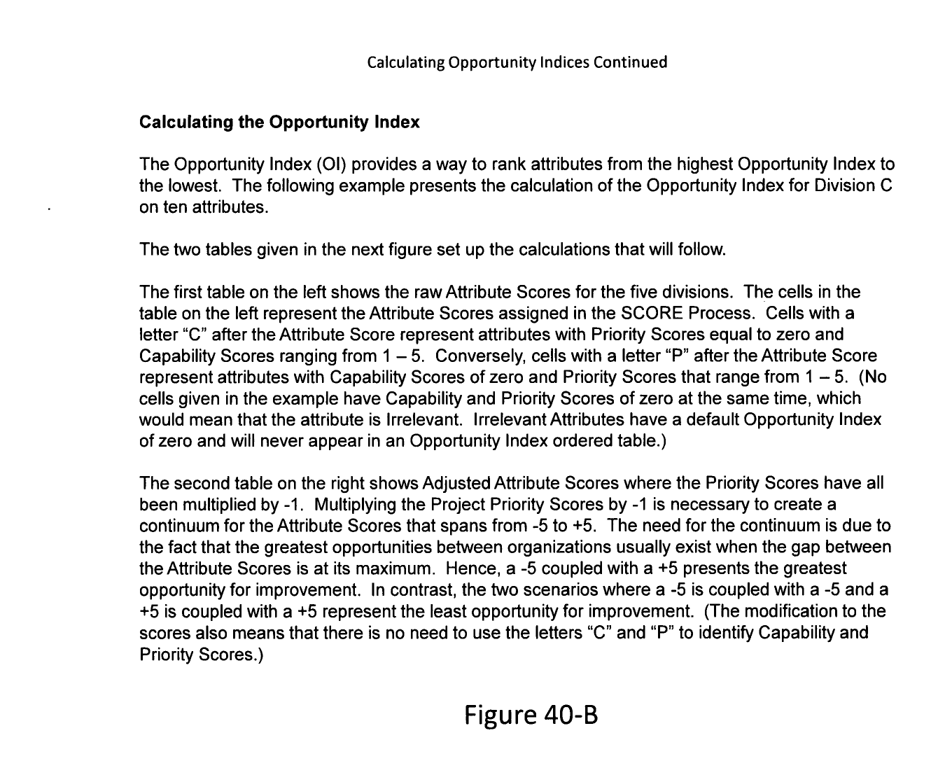

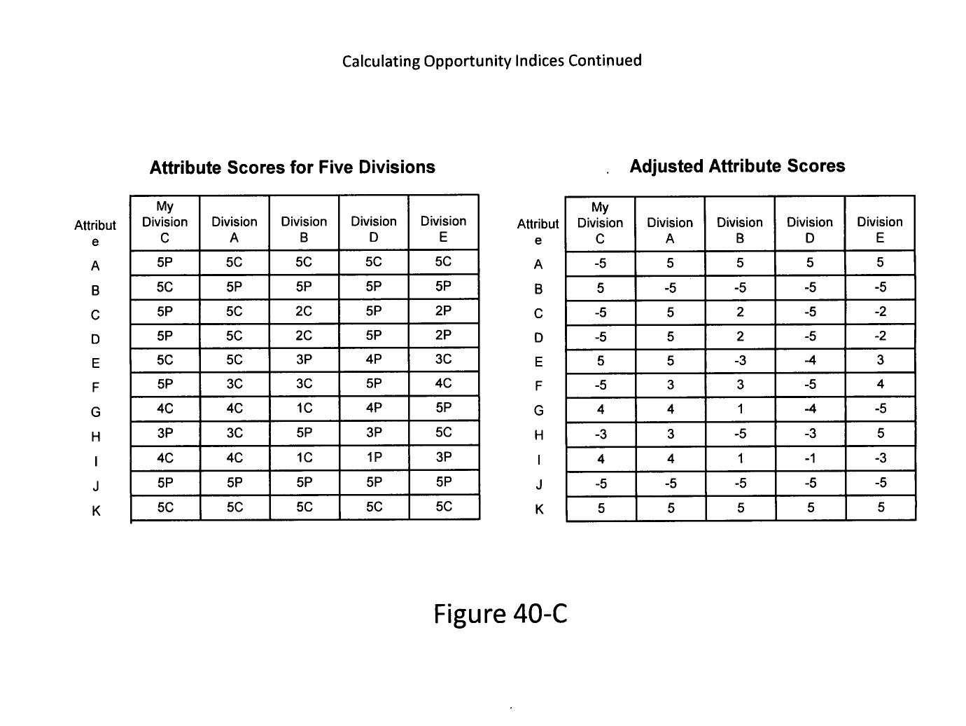

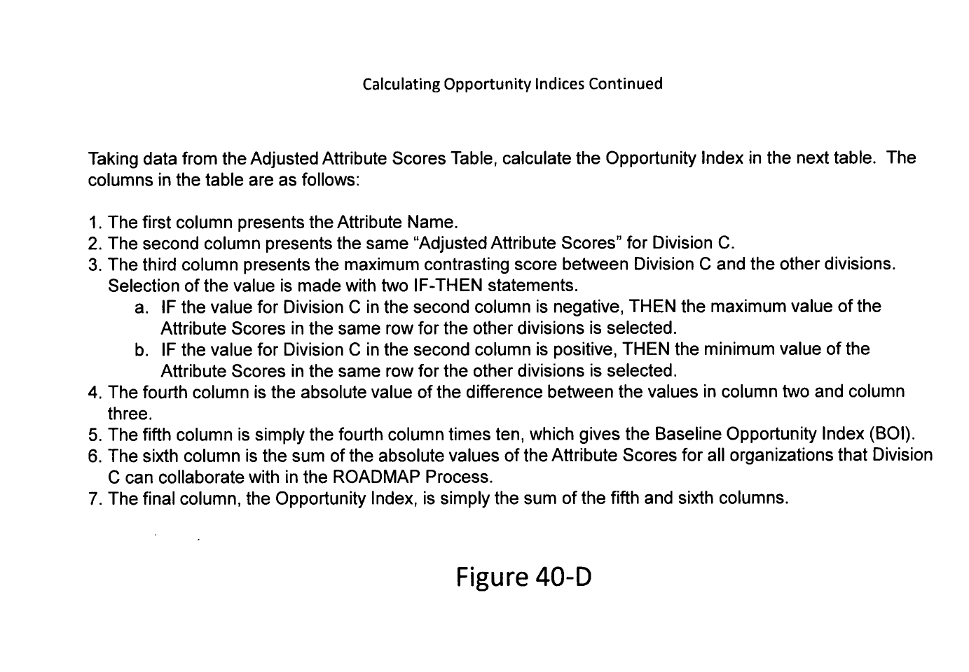

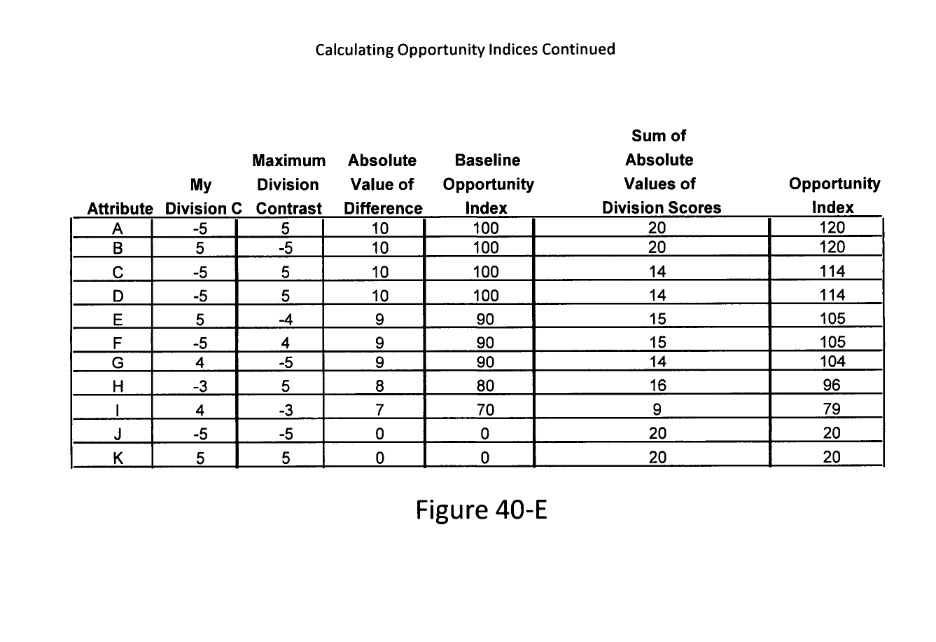

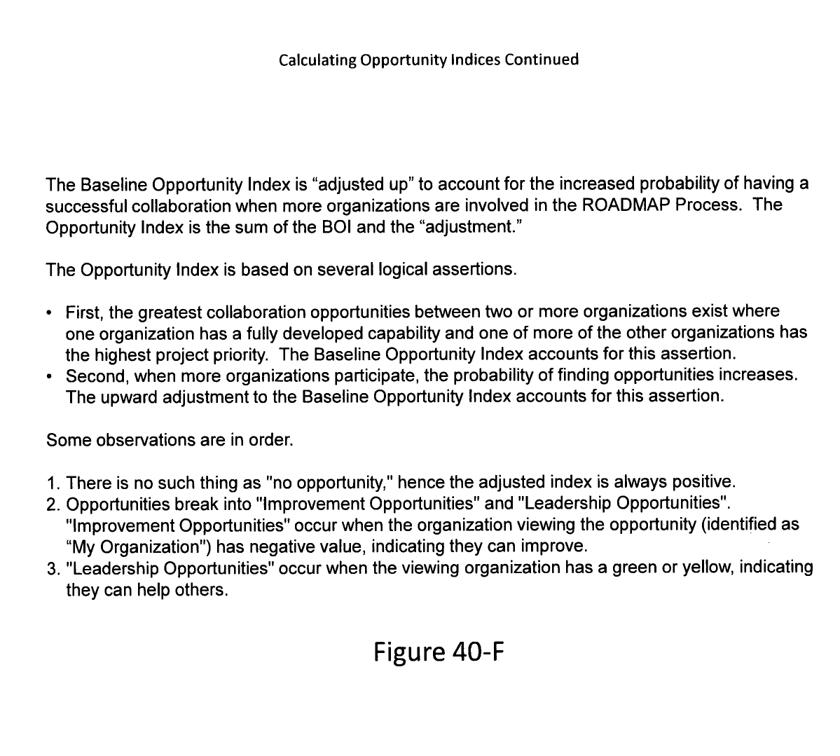

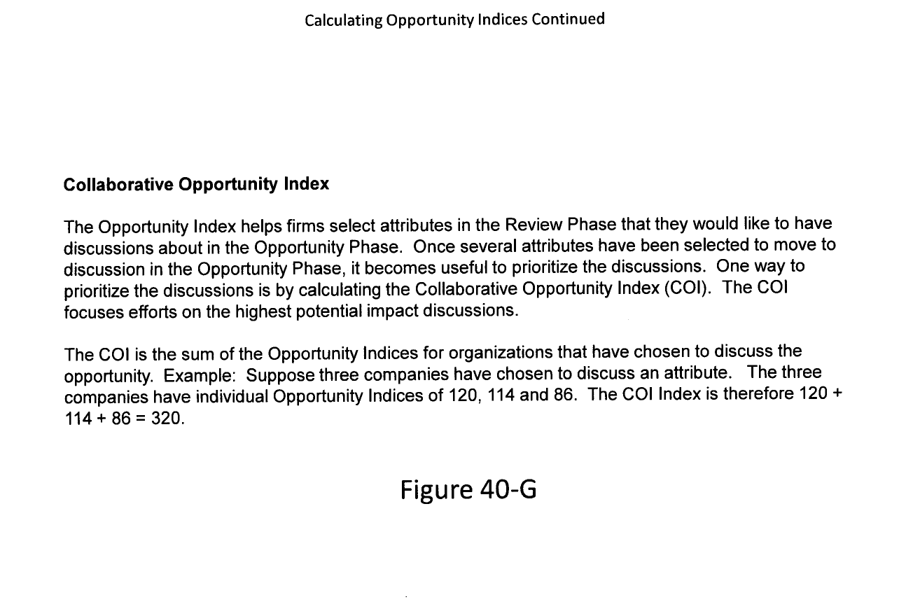

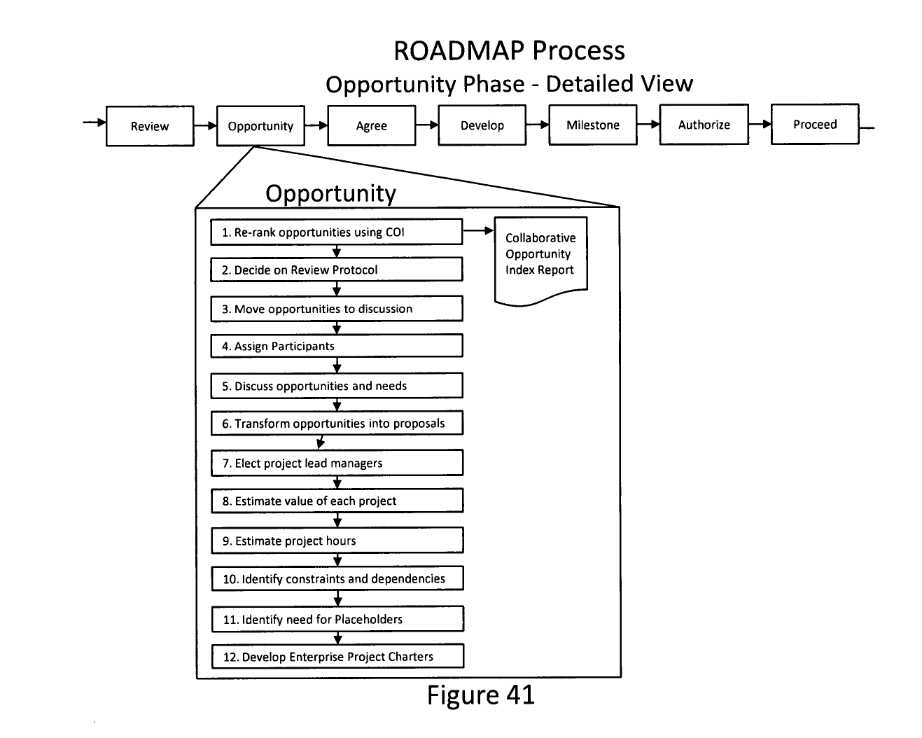

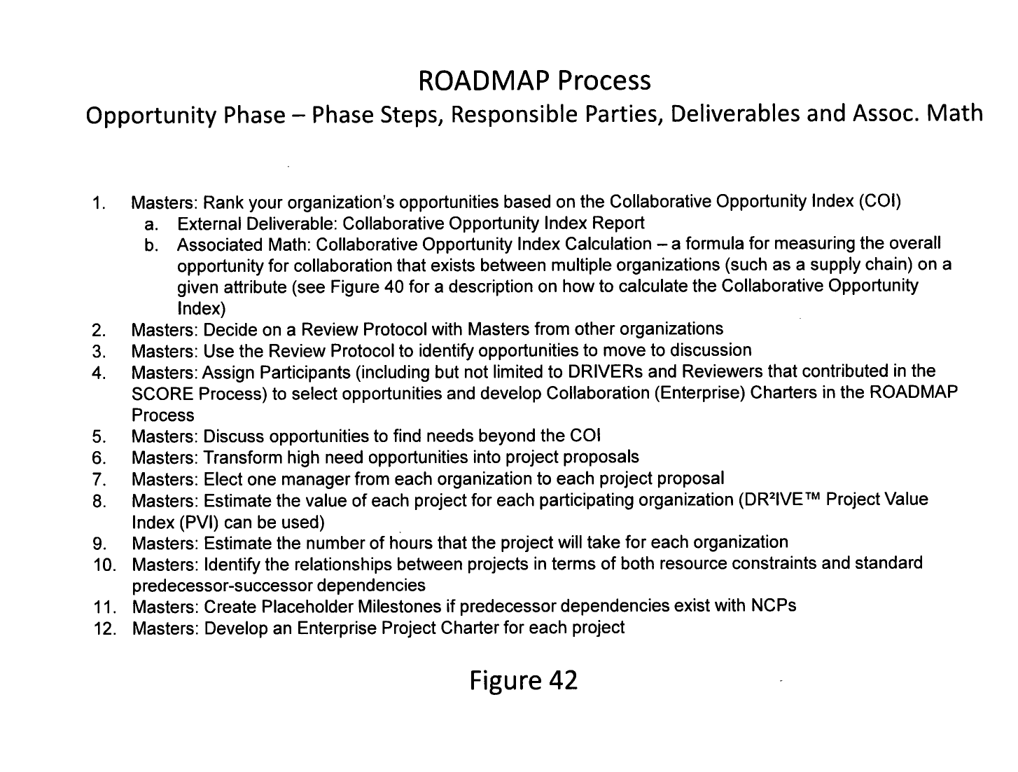

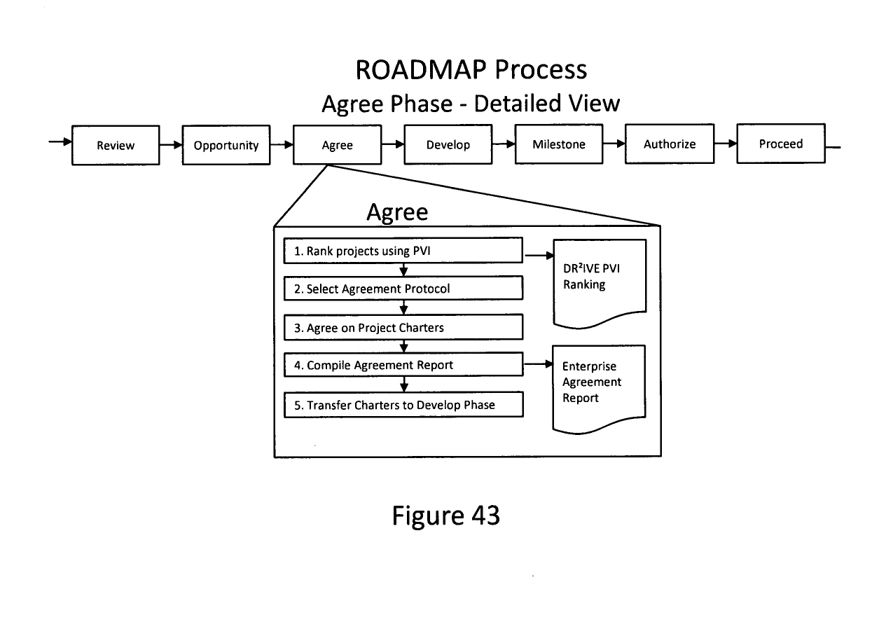

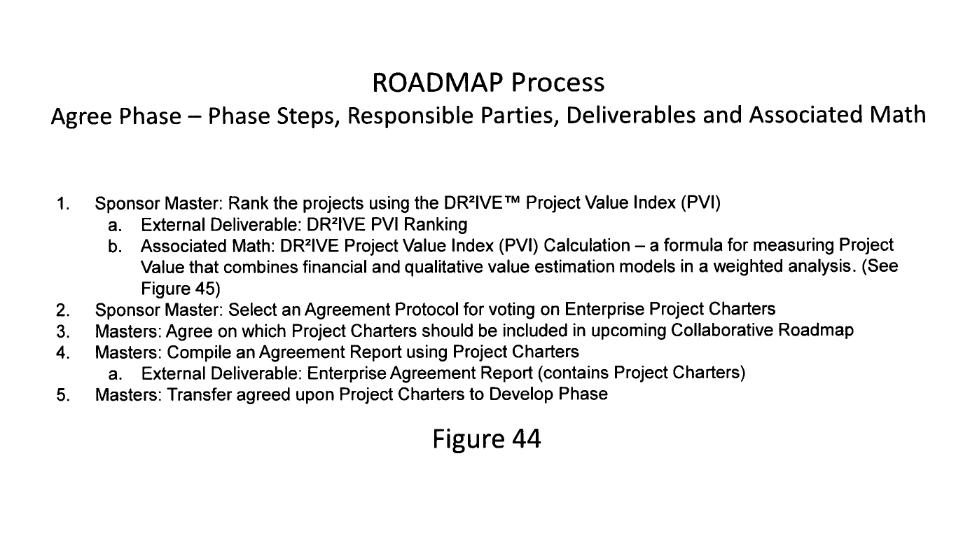

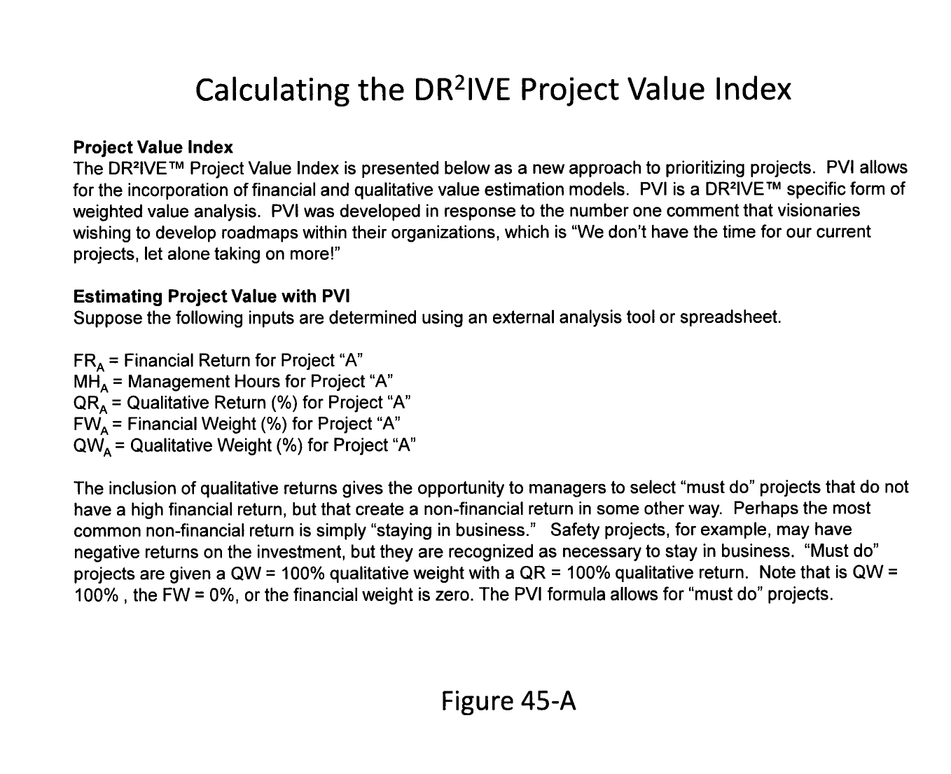

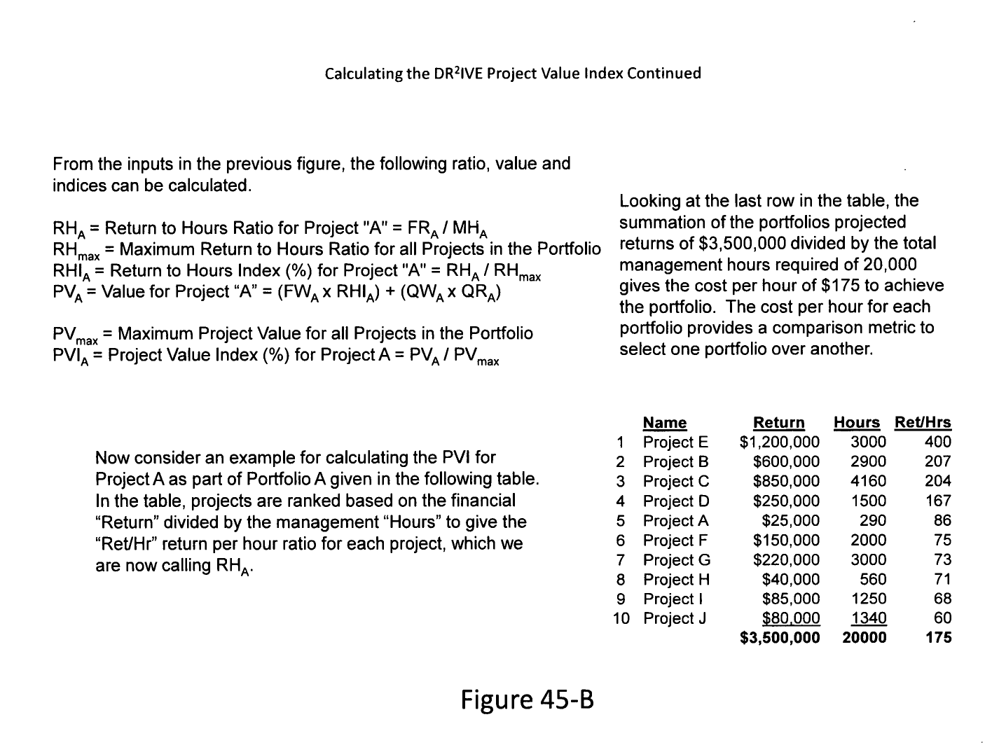

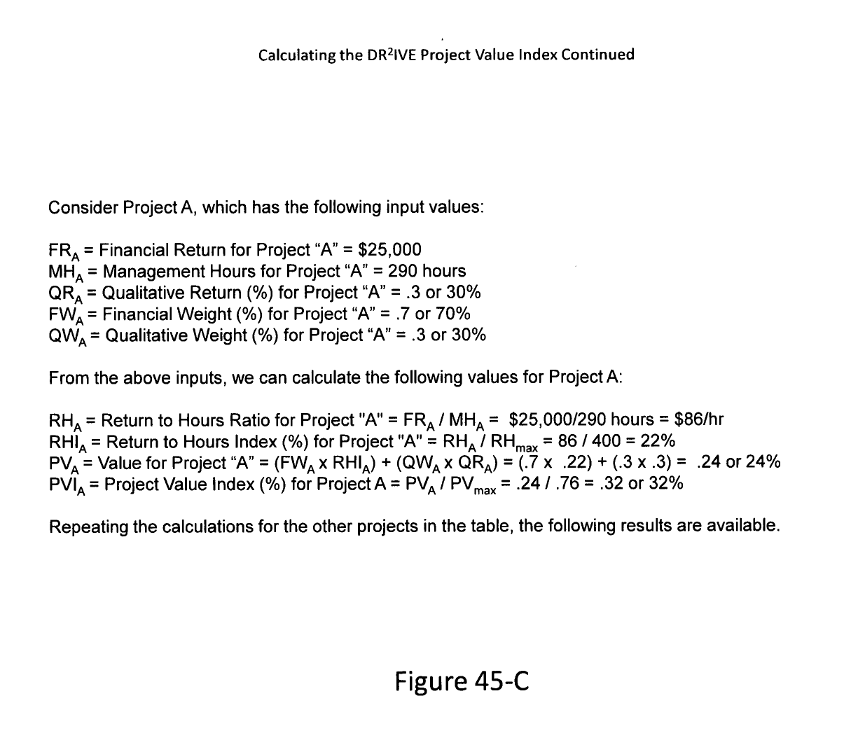

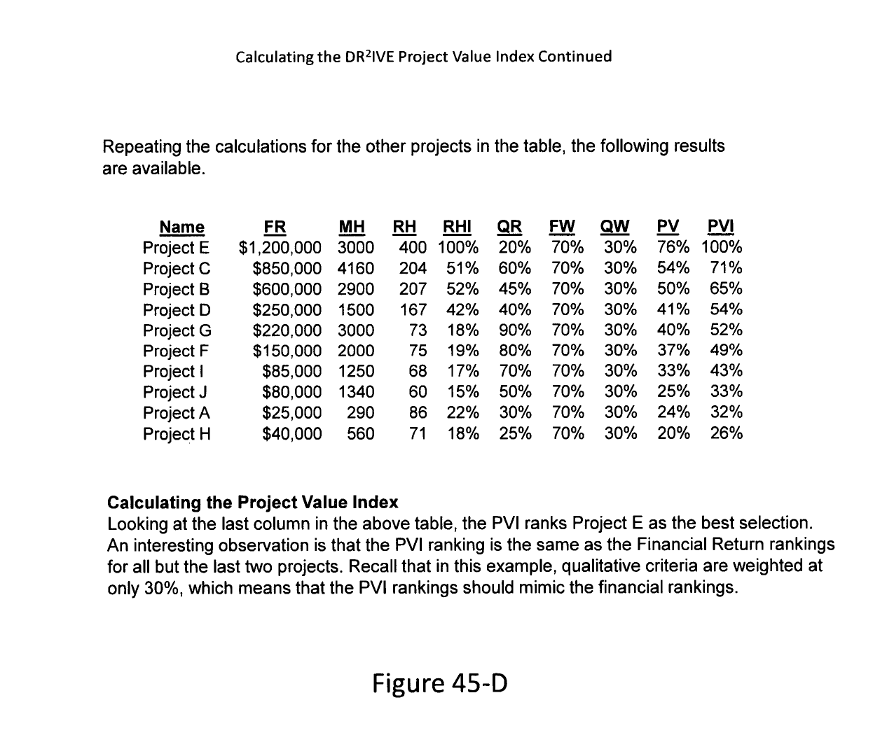

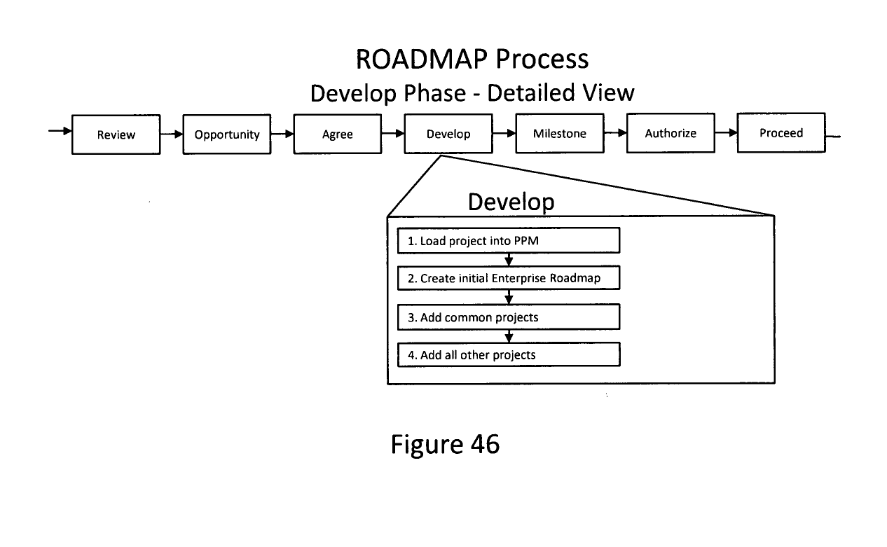

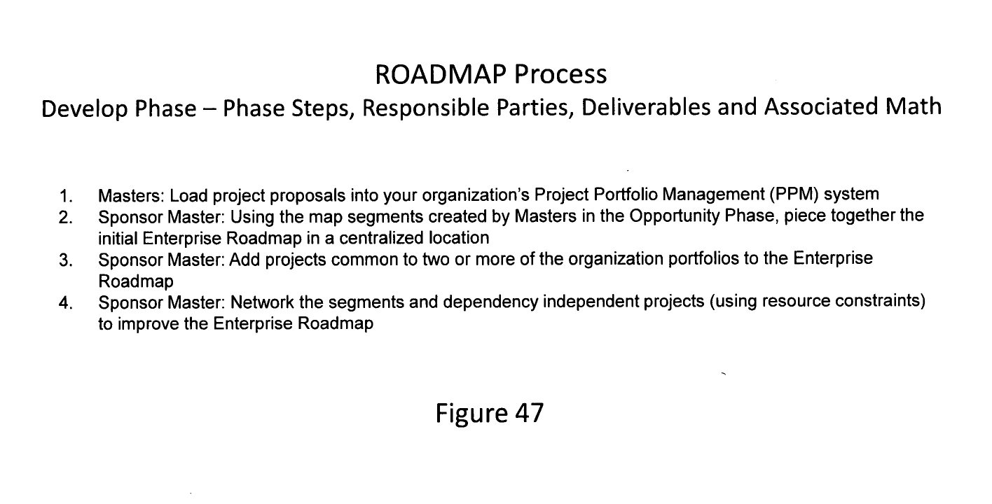

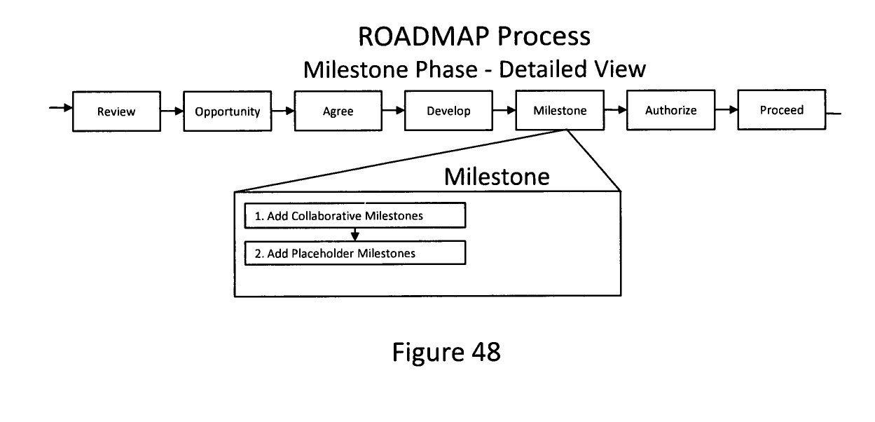

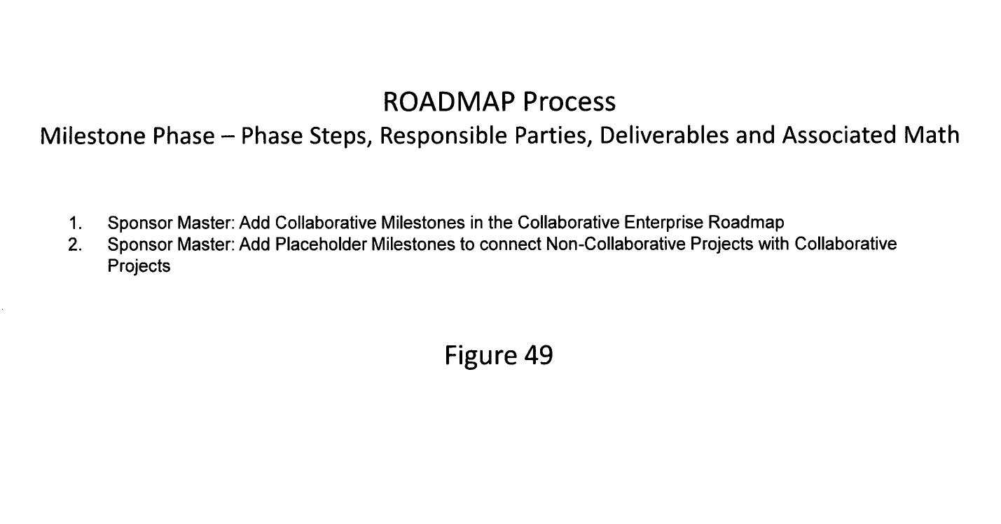

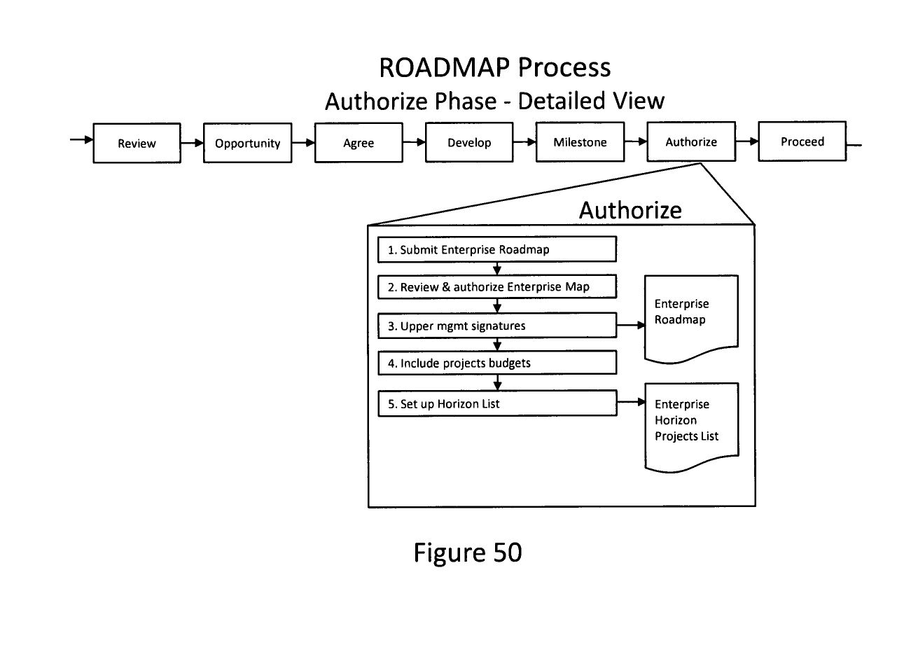

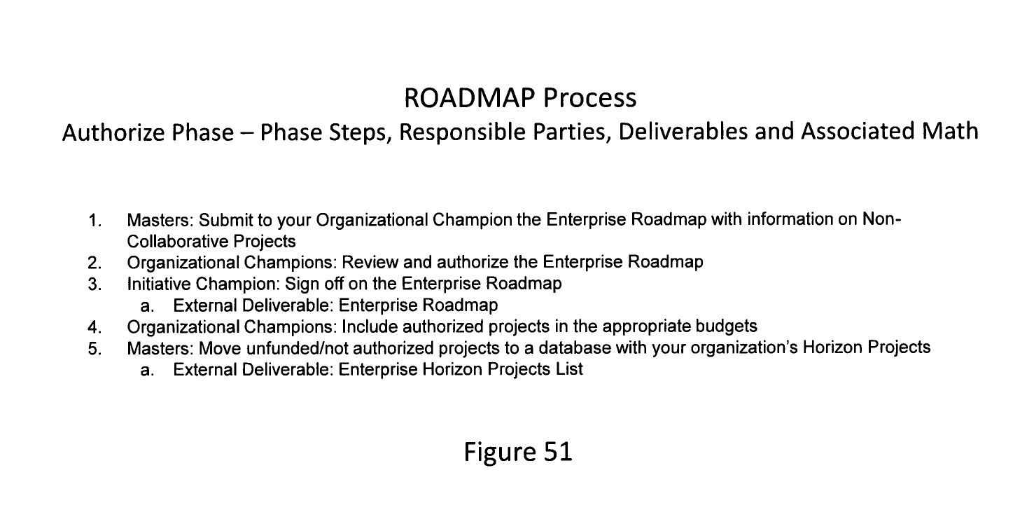

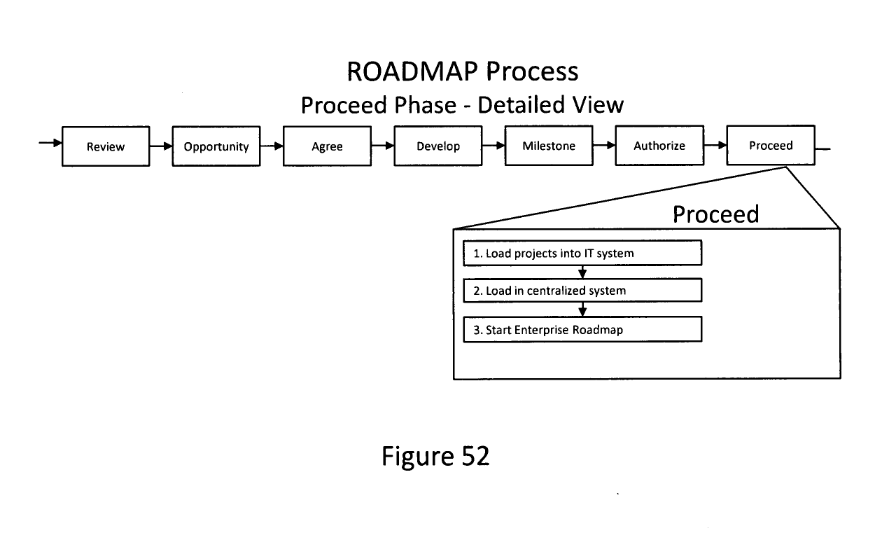

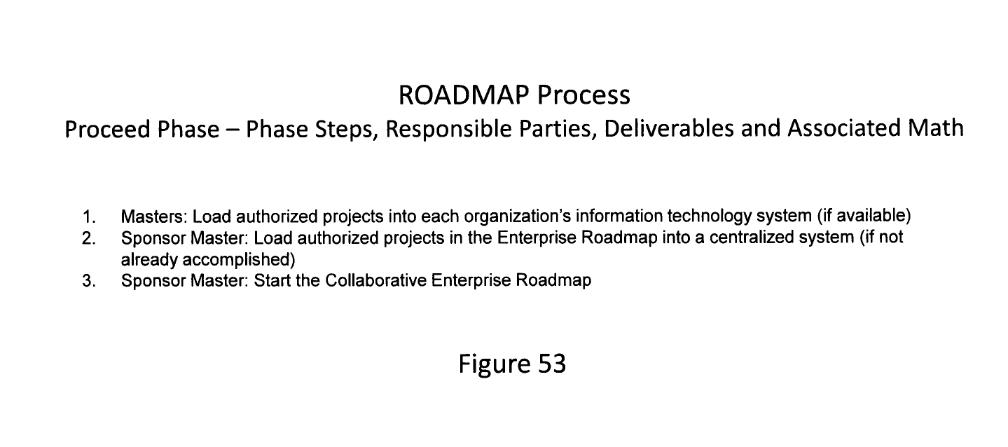

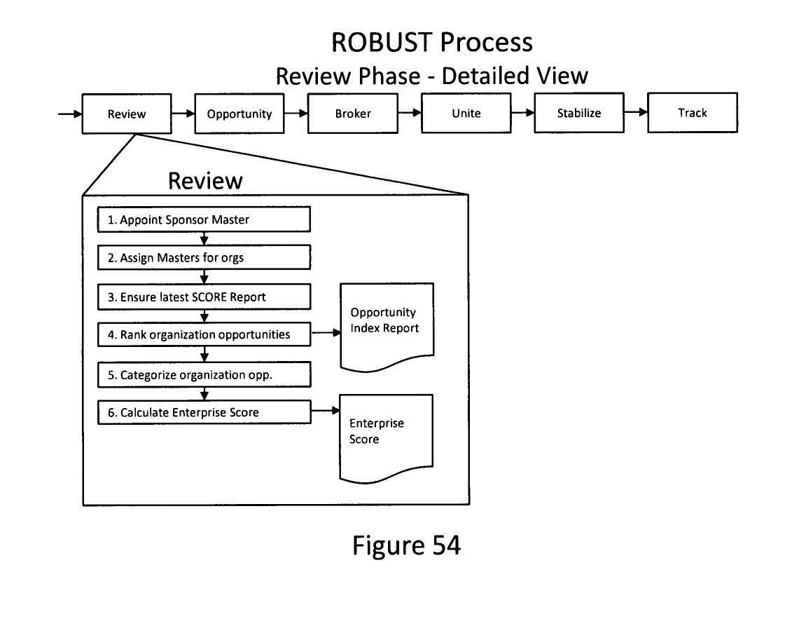

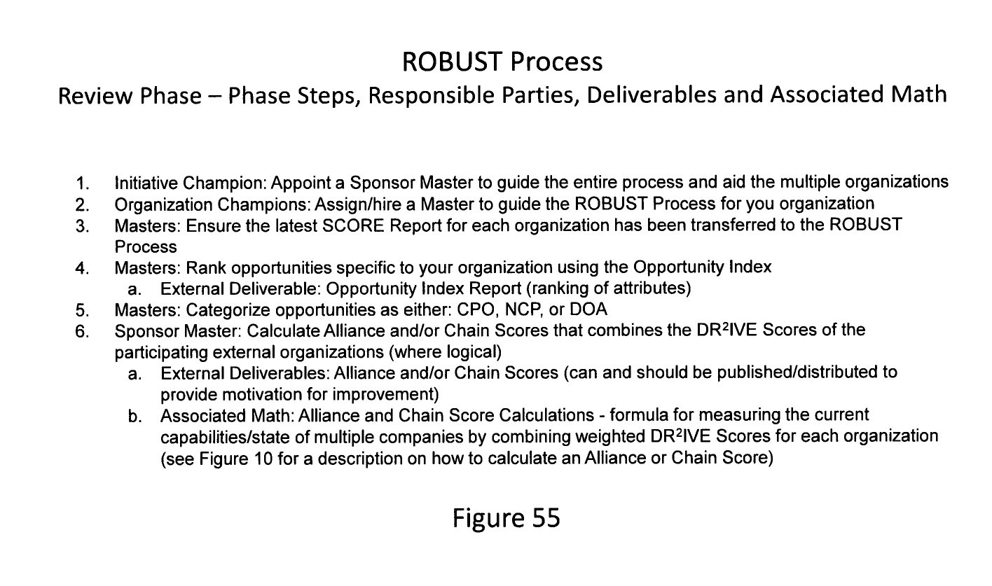

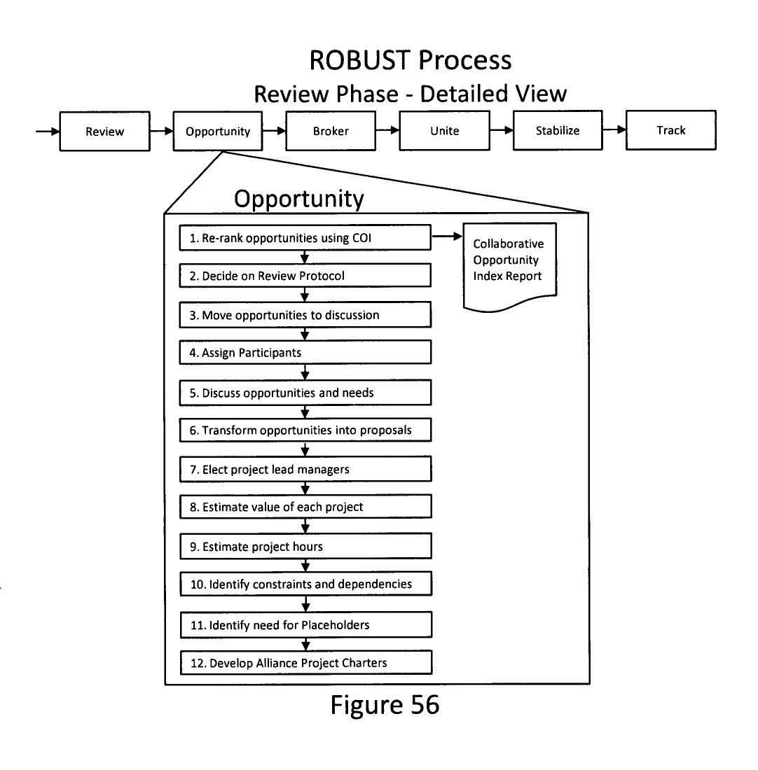

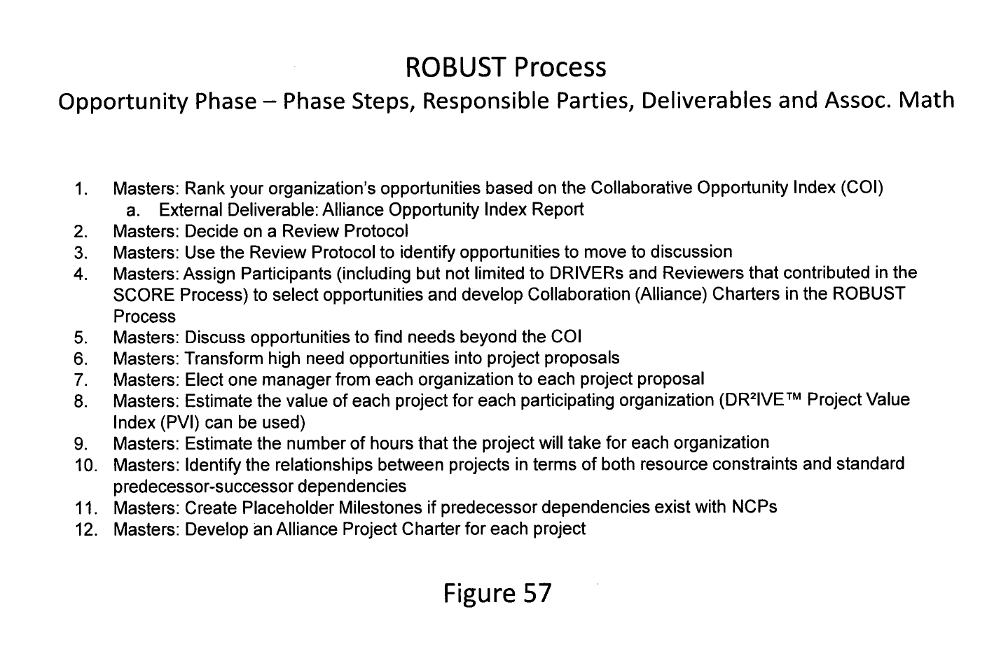

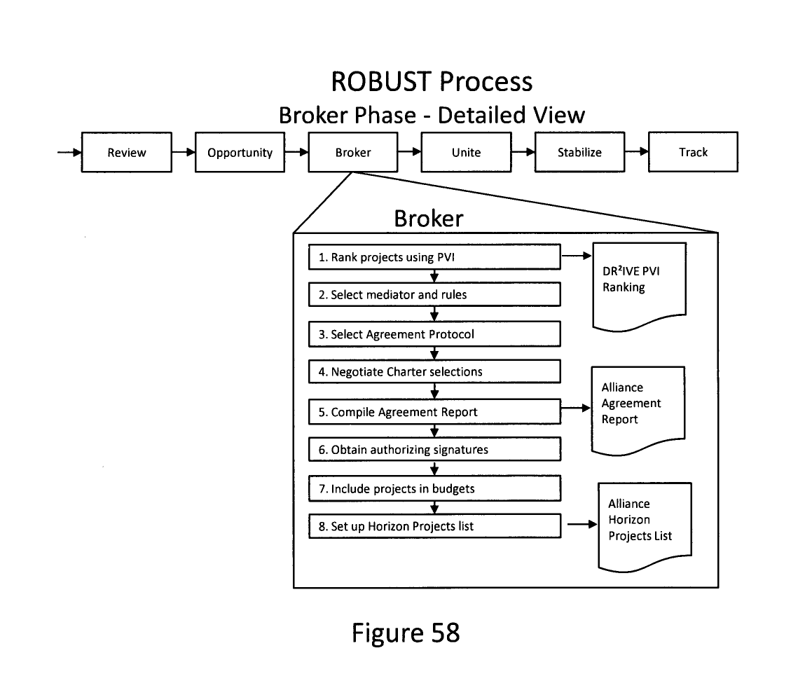

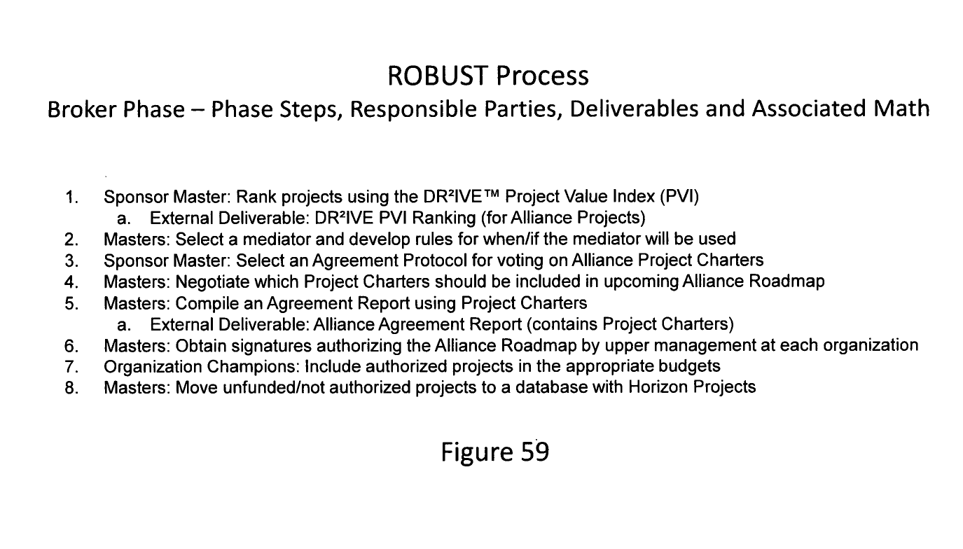

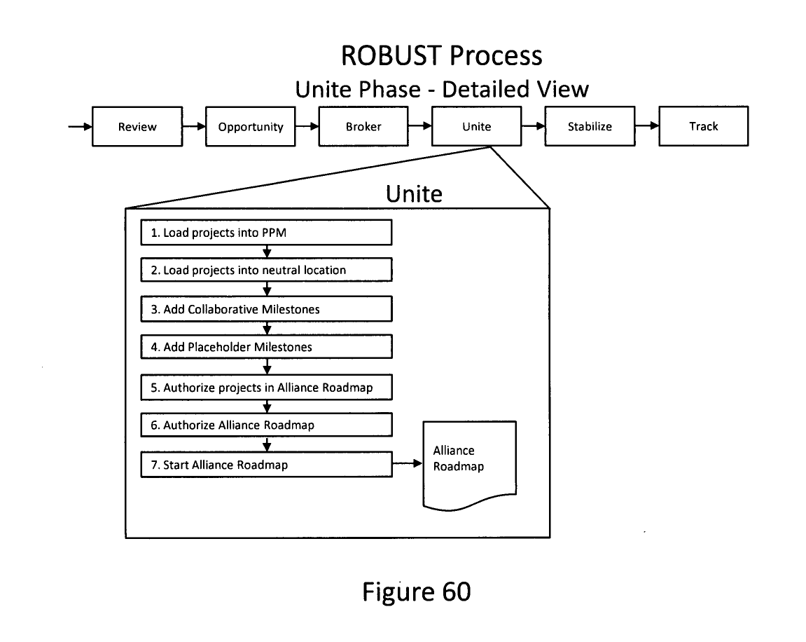

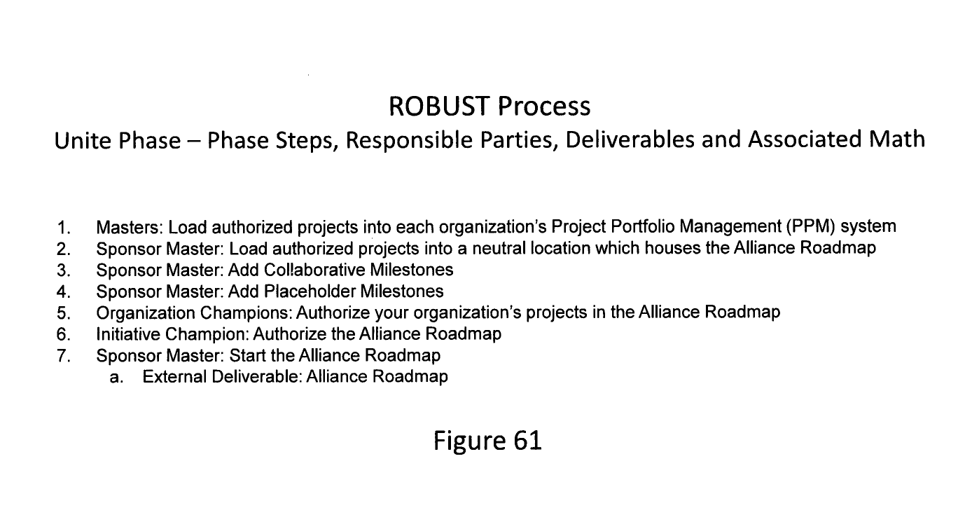

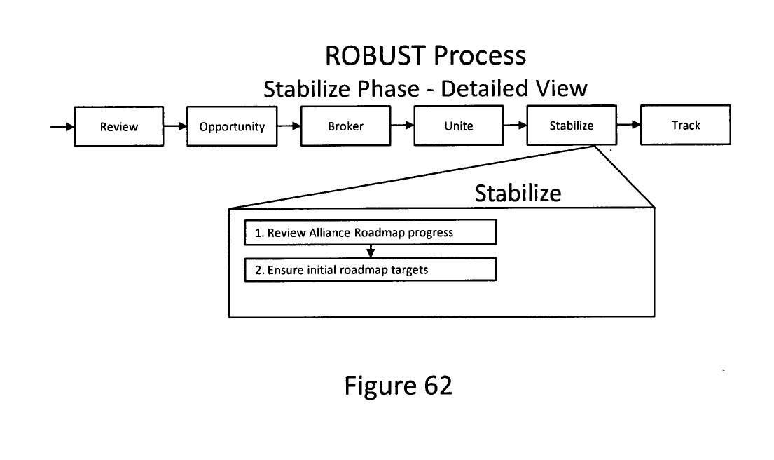

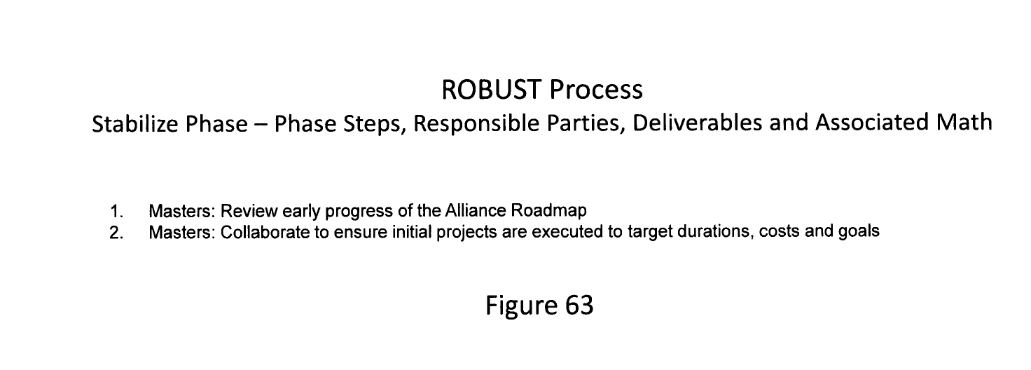

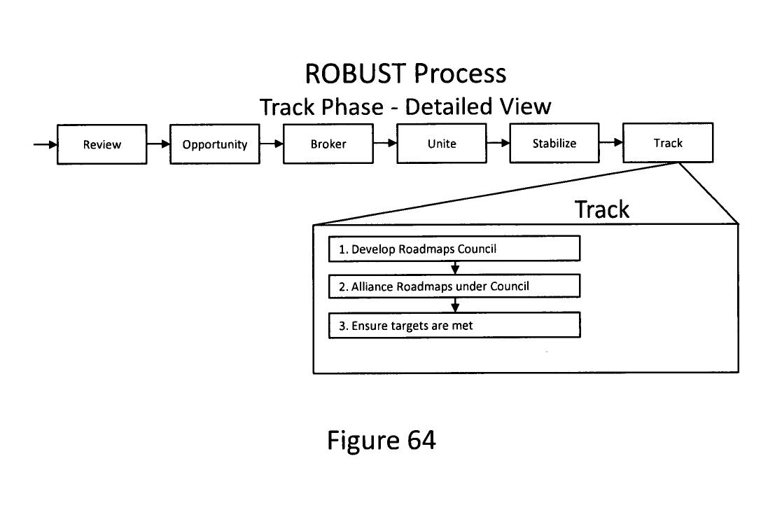

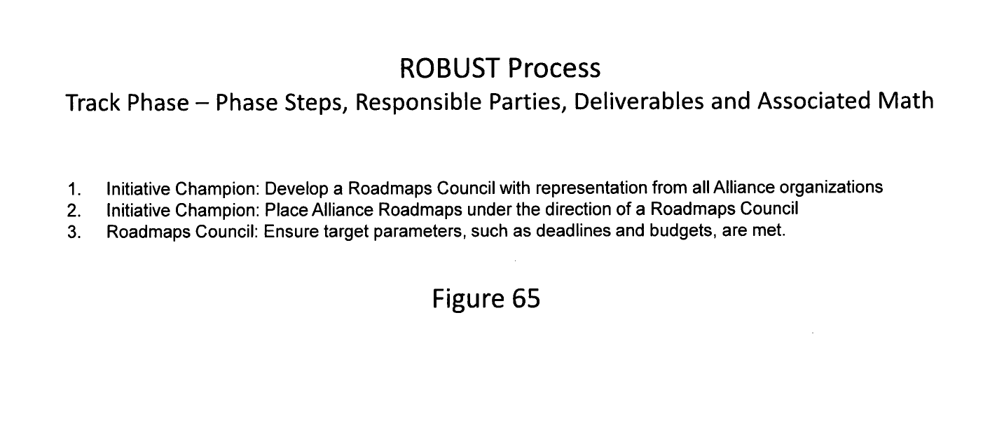

Review, Opportunity, Broker, Unite, Stabilize and Track are the phases comprising the ROBUST Process. Key features are: opportunity identification, collaborative discussions, value estimation, charter development, project selection, brokering and agreement, charter archiving, roadmap unification, roadmap execution, and roadmap tracking. The goal of organizations engaging in the ROBUST Process is to develop Robust Roadmaps to maximize the organization's Robust Frontier, as shown in FIG. 3.

### Extending the Efficient Frontier to the Robust Horizon

Review Phase: Opportunities are generated by comparing capabilities and project priorities for the attributes. The resulting opportunities to transform the attributes into projects are ranked by an Opportunity Index.
Opportunity Phase: Attributes selected by checking Collaborative Project Opportunities (CPO) or Not Collaborative Projects (NCP) in the Review Phase become discussions in the Opportunity Phase. The discussions are held as forums and need little facilitation. A moderator that serves as the intermediary between the organizations facilitates discussions conducted outside of this forum. A ranking of significance is helpful in focusing efforts on the highest potential impact discussions. The Collaborative Opportunity Index (COI) addresses this need. The COI is the sum of the Opportunity Indices for organizations that have chosen to discuss the opportunity.
Broker Phase: Brokering an agreement between the various organizations is the most challenging aspect of developing an Alliance Roadmap.
Unite Phase: Proposals that have been set-up in charters and approved in the Broker Phase are now loaded into two locations. The first location is each organization's Project Portfolio Management (PPM) system. The second location is a neutral location housing the Alliance Roadmap. The neutral location is where dependency relationships, resources allocated, project durations and other data needed to develop, maintain and update the Collaborative Roadmap can be input.
Stabilize Phase: Prior to the Stabilize Phase, approved projects should have been added to the Alliance Roadmap. In addition, Organization Roadmaps and Enterprise Roadmaps have been formally linked with the Alliance Roadmap. The linkages between the Organization, Enterprise and Alliance Roadmaps may be direct links or managed through Placeholder Milestones. The composition of all three roadmaps forms the essence of a Robust Roadmap. At this point, the Robust Roadmap may be unstable due to the complexity of combined resources, collaborative leadership, merged technologies, information system incompatibilities and other uncertainties. Management teams working on the projects must continue to collaborate to ensure that the Robust Roadmaps are executed to target durations, costs and goals.
Track Phase: Alliance Roadmaps are now placed under the direction of the Roadmaps Council. The Roadmaps Council is composed of at least one management representative from each of the organizations in the alliance. It is the responsibility of this group to ensure that projects in the roadmaps are kept on track to meet the target criteria.

The goal of each organization engaging in the ROBUST Process is to maximize the organization's Robust Frontier. Each project proposed within the ROBUST Process must be accepted or rejected on its merits in comparison to all projects, including those resulting from the SCORE and ROADMAP Processes at the organization and enterprise levels. If managers running the ROBUST Process stay true to the goal of maximizing the Robust Frontier, they will have achieved the development of Robust Roadmaps.

I claim as my invention:

1. An integrated management system, which increases the organization's return on investment of the projects undertaken, comprising:
a. a DESIGN process in which a portfolio of projects is proposed, organizations having potential for synergistic engagement are identified and approached, overall resource needs are estimated, the various organizations contributions are assessed, and inter-organizational negotiations are held;
b. a SCORE process, done independently by each organization to assess the contributions the organization can make to the various projects in the DR²IVE portfolio and to share the project rating with the aggregate group;
c. an AUDIT process done at the discretion of each organization to review and finalize a Score Report for distribution to all engaged organizations;
d. a ROADMAP process is carried out collaboratively by the organizations to discuss, assess, plan and coordinate the various project executions; and
e. a ROBUST process for executing the projects, monitoring the execution, and assessing the outcome;
wherein projects are executed using optimized resources and with maximized returns.

2. The integrated management system of claim 1 whereby said DESIGN process further comprises:
a. a Define phase in which an Initiative or Sponsor Champion is selected to oversee the DR²IVE process, identify other organizations within the enterprise with whom to form cooperative engagements, invite representatives from these organizations, and plan the overall DR²IVE process;
b. an Explore phase in which the DR²IVE overview is provided to the contributing organizations, each organization gauges the resources required, the organizational engagements are planned, and project management is proposed;
c. a Select phase in which each organization refines resource needs, presents the model with proposals to management, and acquires preliminary authorization to proceed;
d. an Involve phase in which each organization identifies project management roles, acquires human resources and training, performs opportunity analysis, and formulates execution roadmaps;
e. a Gauge phase in which each organization plans schedules and resources and commits to a common schedule; and
f. a Negotiate phase in which all organizations come together to finalize commitments sharing guidelines, schedules and engagements;
wherein a portfolio of projects is proposed, organizations having potential for synergistic engagement are identified and approached, overall resource needs are estimated, the various organizations contributions are assessed, and inter-organizational negotiations are held.

3. The integrated management system of claim 1 whereby said SCORE process further comprises:
a. a Score phase in which core competency step charts are created by each organization;
b. a Consensus phase in which the core competency step charts are compiled and a consensus index is created;
c. a Optimize phase in which the consensus index is refined;
d. a Review phase in which an overall score report is created from the consensus index; and
e. an Engage phase in which the score report is distributed and reviewed by the entire group of organizations;
wherein each organization assesses the contributions the organization can make to the various projects in the DR²IVE portfolio and to share the project rating with the aggregate group.

4. The integrated management system of claim 1 whereby said AUDIT process further comprises:
a. an Analyze phase in which a Discrepancy Report is generated from the Unofficial Score Report;
b. an Understand phase in which resolution of as many discrepancies as possible is done through discussion of the Discrepancy Report attributes;
c. a Discover phase in which a physical Discovery Visit to one or more facilities of the organization undergoing the AUDIT Process is planned and completed;
d. an Integrate phase in which a new SCORE Report can be reviewed and approved by all relevant parties; and
e. a Transfer phase in which the participants who helped with the AUDIT Process will see the completed Official SCORE Report for the first time;
wherein, at the discretion of each organization, a review and finalization of the Score Report is completed for distribution to all engaged organizations.

5. The integrated management system of claim 1 whereby said ROADMAP process further comprises:
a. a Review phase in which opportunities are generated, ranked by opportunity index, summarized, reviewed, and placed into one of three categories: Collaborative Project Opportunity(CPO), Not Collaborative Project(NCP), and/or Dead Opportunity on Arrival(DOA);
b. an Opportunity phase in which the quantitative and qualitative returns from projects are indexed by the Project Value Index (PVI);
c. an Agree phase in which an Agreement Report is generated listing the projects that have been selected;
d. a Develop phase in which the selected projects are now loaded into a Project Portfolio Management (PPM) system;
e. a Milestone phase in which two types of milestones are added, Collaborative Milestones and Roadmap Placeholder Milestone;
f. an Authorize phase in which authorization is obtained from executive management for the portfolio itself; and
g. a Proceed phase in which the roadmap is entered into the organization's information technology system;
wherein the organization collaboratively carries out discussing, assessing, planning and coordinating the various project executions.

6. The integrated management system of claim 1 whereby said ROBUST process further comprises:
a. a Review phase in which projects are ranked by an Opportunity Index;
b. an Opportunity phase in which CPO's or NCP's identified in the Roadmap process, are discussed in remotely attended forums facilitated by a moderator, also serving as an intermediary between the organizations, ranking the significance of the projects to focus on those with highest potential impact; a Collaborative Opportunity Index (COI), the sum of the Opportunity Indices for the various organizations, is created;
c. a Broker phase in which an agreement between the various organizations is reached;
d. a Unite phase in which proposals that have been chartered and approved are loaded into each organization's Project Portfolio Management (PPM) system and in a neutral location housing the Alliance Roadmap;
e. a Stabilize phase in which the various management teams working on the projects collaborate to ensure that the Robust Roadmaps are executed to target durations, costs and goals by overcoming any instabilities in the Robust Roadmap due to the complexity of combined resources, collaborative leadership, merged technologies, information system incompatibilities and other uncertainties; and
f. a Track phase in which a Roadmaps Council is created composed of at least one management representative from each of the organizations in the alliance, to track the cooperative effort;
wherein the projects are executed, monitored and outcomes assessed.
